(19) United States
(12) Patent Application Publication
(10) Pub. No.: US 2017/0111612 A1
(43) Pub. Date: Apr. 20, 2017

(54) MANAGEMENT SYSTEM, TRANSMISSION TERMINAL, AND METHOD FOR TRANSMISSION MANAGEMENT

(71) Applicant: Kumiko YOSHIDA, Tokyo (JP)

(72) Inventor: Kumiko YOSHIDA, Tokyo (JP)

(21) Appl. No.: 15/291,205

(22) Filed: Oct. 12, 2016

(30) Foreign Application Priority Data
Oct. 16, 2015 (JP) 2015-204929
Dec. 8, 2015 (JP) 2015-239181

(51) Int. Cl. H04N 7/14; H04N 7/15; H04L 29/06

(52) U.S. Cl. CPC H04N 7/147; H04L 65/1069; H04L 65/1093; H04N 7/15; H04L 65/403

(57) ABSTRACT

To transmit content data to a second terminal while transmitting content data to a first terminal, a management system includes a receiver configured to receive a request sent from a first terminal for establishing a first session between the first terminal and a second terminal, and a session controller configured to send the request for establishing the first session to the second terminal while a second session, other than the first session, is underway between the first terminal and a third terminal, upon receiving the request for establishing the first session.

### CROSS-REFERENCE TO RELATED APPLICATIONS

The present application claims the benefit of priority under 35 U.S.C. §119 of Japanese Patent Application No. 2015-204929, filed Oct. 16, 2015, and Japanese Patent Application No. 2015-239181, filed Dec. 8, 2015, the contents of which are incorporated herein by reference in their entirety.

### BACKGROUND OF THE INVENTION

1. Field of the Invention

The present invention relates to management systems, transmission terminals, and methods for transmission management.

2. Description of the Related Art

In recent years, there has been a distribution system for distributing content data such as an image captured by a live-relay camera provided on a distributor-terminal to multiple terminals through a communication network such as the Internet. For example, an image and sound of a nursery school and a kindergarten are distributed to terminals of parents. The distribution system enables parents to see circumstances of the school and children, and therefore helps improving security of the school and provides relief for the parents.

Further, Japanese Unexamined Patent Application Publication No. 2005-293065 discloses a technique of establishing a new session in order to transmit and receive additional data which is not supported by a service employed for communicating with the communication partner.

### SUMMARY OF THE INVENTION

One aspect of the present invention provides a management system including a receiver configured to receive a request sent from a first terminal for establishing a first session between the first terminal and a second terminal, and a session controller configured to send the request for establishing the first session to the second terminal while a second session, other than the first session, is underway between the first terminal and a third terminal, upon receiving the request for establishing the first session.

### BRIEF DESCRIPTION OF THE DRAWINGS

FIG. 1 is a Schematic view of a transmission system according to a first embodiment of the present invention;

FIG. 2 is an external view of a terminal according to the first embodiment;

FIG. 3 is a diagram illustrating a hardware configuration of the terminal according to the first embodiment of the present invention;

FIG. 4 is a diagram illustrating a hardware configuration of a management system, a relay device, and a program-providing system, or a maintenance system according to the first embodiment of the present invention;

FIG. 5 is a functional block diagram of the terminal, the relay device, and the management system included in the transmission system according to the first embodiment;

FIG. 6 is a conceptual diagram illustrating a relay device management database (DB), according to the first embodiment;

FIG. 7 is a conceptual diagram illustrating a terminal authentication management DB, according to the first embodiment;

FIG. 8 is a conceptual diagram illustrating a terminal management DB, according to the first embodiment;

FIG. 9 is a conceptual diagram illustrating a call list management DB, according to the first embodiment;

FIG. 10 is a conceptual diagram illustrating a session management DB, according to the first embodiment;

FIG. 11 is a conceptual diagram illustrating a relay device selection management DB, according to the first embodiment;

FIG. 12 is a conceptual diagram illustrating an entrance management DB, according to the first embodiment;

FIG. 13 is a conceptual diagram illustrating a conference room management DB, according to the first embodiment;

FIG. 14 is a sequence diagram of the transmission system in a case of calling during distribution, according to the first embodiment;

FIG. 15 is a flowchart illustrating a process performed by the distributor-terminal when starting call-communication during distribution, according to the first embodiment;

FIG. 16 is a flowchart illustrating a session management process, according to the first embodiment;

FIG. 17 is a flowchart illustrating a call-receiving process performed by a counterpart-terminal, according to the first embodiment;

FIGS. 18A through 18D are drawings illustrating examples of a screen display of the distributor terminal, according to the first embodiment;

FIGS. 19A through 19F are drawings illustrating examples of a screen display of a receiver-terminal, according to the first embodiment;

FIG. 20 is a conceptual diagram illustrating transmission/reception of image data, sound data, and various types of management information in the transmission system, according to the first embodiment;

FIG. 21 is a drawing illustrating an example of a new conference room creating image displayed for creating a new conference room, according to the first embodiment;

FIG. 22 is a sequence diagram illustrating a process of creating a new conference room, according to the first embodiment;

FIG. 23 is a drawing illustrating an example of a conference room detail screen indicative of detailed information of a conference room, according to the first embodiment;

FIG. 24 is a drawing illustrating an example of a conference room editing image displayed for editing conference room information, according to the first embodiment;

FIG. 25 is a sequence diagram illustrating a process of displaying a conference room list and editing a conference room, according to the first embodiment;

FIG. 26 is a sequence diagram illustrating a process of entering a conference room selected from the conference room list, according to the first embodiment;

FIG. 27 is a flowchart illustrating a process in accordance with a result of a determination regarding entrance, according to the first embodiment;

FIG. 28 is a drawing illustrating an example of an image which contains counterpart-terminal state listing information, according to the first embodiment;

FIG. 29 is a sequence diagram illustrating a process of displaying the image which contains the counterpart-terminal state listing information on the terminal, according to the first embodiment;

FIG. 30 is a sequence diagram illustrating a process of requesting for starting a call-communication, according to the first embodiment;

FIG. 31 is a sequence diagram illustrating a process of allowing the request for starting the call-communication, according to the first embodiment;

FIG. 32 is a sequence diagram illustrating the processing of rejecting the request for starting the call-communication, according to the first embodiment;

FIG. 33 is a sequence diagram illustrating a process of requesting for relaying call-communication data, according to the first embodiment;

FIG. 34 is a sequence diagram illustrating a process of requesting for a permission to leave an call-communication data transmitting session, according to the first embodiment;

FIG. 35 is a functional block diagram illustrating of a terminal, a relay device, and a management system included in a transmission system according to a second embodiment;

FIG. 36 is a conceptual diagram illustrating a quality setting management table, according to the second embodiment;

FIG. 37 is a sequence diagram illustrating an example of a process of controlling a communication band, according to the second embodiment;

FIG. 38 is a flowchart illustrating an example of a band information acquiring process, according to the second embodiment;

FIG. 39 is a flowchart illustrating an example of a quality determining process, according to the second embodiment; and

FIGS. 40A and 40B are drawings illustrating examples of a display screen on the receiver-terminals in an event that a communication band for distributing an image is smaller than a predetermined threshold, according to the second embodiment.

### DESCRIPTION OF THE EMBODIMENTS

The conventional conference system and the distribution system have a problem that, during distribution of content data to a communication partner, content data cannot be transmitted to another partner.

Therefore, the objective of the present invention is for providing a technique for transmitting content data to a second terminal, while transmitting content data to a first terminal.

According to the disclosed technique, transmitting content data to a second terminal, while transmitting content data to a first terminal is possible.

### First Embodiment

<<Overall Configuration of Embodiments>>

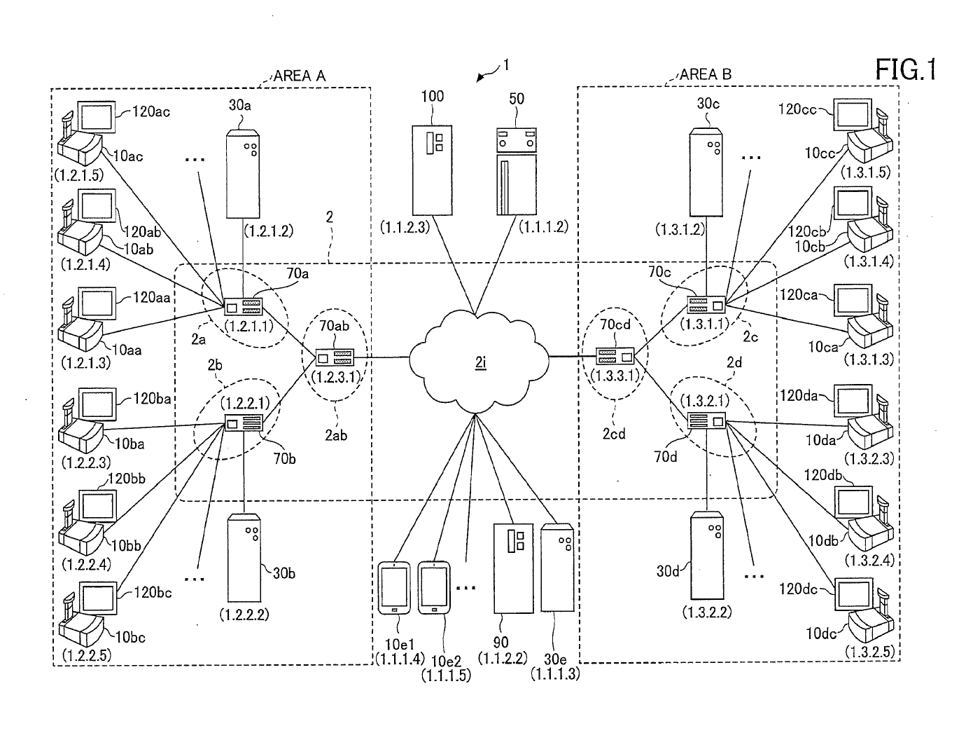

In the following the first embodiment of the present invention will be described, with reference to FIG. 1 through FIG. 34. FIG. 1 is a schematic view of a transmission system 1 according to the embodiments of the present invention. First, an overview of the embodiments will be described with reference to FIG. 1.

The transmission system 1 includes a data-providing system which performs one-way transmission of content data from a terminal to another terminal via a management system 50 and a communication system which performs mutual transmission of information including information that conveys feelings, etc., among multiple terminals via the management system 50. The communication system enables multiple communication terminals (i.e. “terminal”) to intercommunicate information including information that conveys feelings via a communication management system (i.e. “management system”), as exemplified by a teleconference system, a video phone system, an audio teleconference system, an audio phone system, a personal computer (PC) screen sharing system, etc.

The transmission system 1 illustrated in FIG. 1 includes multiple terminals (10aa, 10ab, etc.), displays (120aa, 120ab, etc.) provided for respective terminals (10aa, 10ab, etc.), multiple relay devices (30a, 30b, 30c, 30d, and 30e), the management system 50, a program-providing system 90, and a maintenance system 100.

In the following description of the embodiments, an unspecified terminal among the terminals (10aa, 10ab, etc.) is simply referred to as a “terminal 10”. An unspecified display among the displays (120aa, 120ab, etc.) is simply referred to as a “display 120”. An unspecified relay device among the relay devices (30a, 30b, 30c, 30d, and 30e) is simply referred to as a “relay device 30”.

The terminal 10 receives and transmits content data such as image data and sound data. That is to say, telecommunication according to the embodiments of the present, invention includes not only receiving and transmitting sound data, but also receiving and transmitting image data. Alternatively, the terminal 10 may only receive and transmit sound data, not image data. The terminal 10 may be a smartphone, laptop PC, etc., which may be connected to the management system 50, etc., via a transmission network such as a cellular phone network, a wireless LAN, and the Internet.

Although image data exemplified in the following description of the embodiments is a movie data, image data may be still image data and may include both movie data and still image data.

The relay devices 30 relays image data and sound data among multiple terminals. The management system 50 manages intercommunication of the multiple terminals 10 which receive and transmit content data. Intercommunication of the multiple terminals 10 involves information relating to the terminal 10, information relating to the relay devices 30 that relay intercommunication among the terminals 10, and information relating to settings of intercommunication of the terminals 10 via the relay devices 30. More specifically, the management system 50 stores operation status and IP addresses of the respective relay devices 3, and information indicative of each of the relay devices 30 assigned to the respective relay devices 30. The management system 50 further stores authentication information (ID and password of each of the terminals 10) for the terminals 10 to login to the transmission system 1, information indicative of an address registered for each of the terminals 10, and information relating to an intercommunication (i.e. session) performed by the relay devices 30 and the relay devices 30. The management system 50 further stores information relating to settings of intercommunication that may be joined by one or more designated terminals 10. The details of the information stored by the management system 50 will be explained hereinafter.

Multiple routers (70a, 70b, 70c, 70d, 70ab, and 70cd) illustrated in FIG. 1 select a route that is the most suitable for transmitting image data and sound data. In the following description of the embodiments, an unspecified router among the routers (70a, 70b, 70c, 70d, 70ab, and 70cd) is simply referred to as a “router 70”.

The program-providing system 90 is provided with a hard disk (RD) (not illustrated in FIG. 1) storing terminal-oriented programs executed for implementing functions/units provided on the terminals 10. The program-providing system 90 is capable of transmitting the terminal-oriented programs to each of the terminals 10. The HD provided on the program-providing system 90 further stores relay device-oriented programs executed for implementing functions/units of the relay devices 30. The program-providing system 90 is capable of transmitting the relay device-oriented programs to each of the relay devices 30. The HD provided on the program-providing system 90 further stores transmission management programs, which are executed for implementing functions/units of the management system 50. The program-providing system 90 is capable of transmitting the transmission management programs to the management system 50.

The maintenance system 100 is a computer that performs maintenance and management for at least one of the terminal 10, the relay device 30, the management system 50, and the program-providing system 90. For example, in a case where the maintenance system 100 is located in one country whereas at least one of the terminal 10, the relay device 30, the management system 50, and the program-providing system 90 are outside the country, the maintenance system 100 performs maintenance and management for the at least one of the terminal 10, the relay device 30, the management system 50, and the program-providing system 90, remotely via a communication network 2. In addition, the maintenance system 100 performs maintenance, such as management of model numbers, serial numbers, purchasers, maintenance inspections, and histories of malfunctions, for at least one of the terminal 10, the relay device 30, the management system 50, and the program-providing system 90, without utilising the communication network 2.

Further, the terminals (10aa, 10ab, 10ac, etc.), the relay device 30a, and the router 70a are interconnected via a local area network (LAN) 2a for communicating with each other. The terminals (10ba, 10bb, 10bc, etc.), the relay device 30b, and the router 70b are interconnected via a LAN 2b for communicating with each other. In addition, the LAN 2a and the LAN 2b are connected via a designated line 2ab that employs a router 70ab for communicating with each other. The connections for communication are constituted inside a predetermined area A.

On the other hand, the terminals (10ca, 10cb, 10cc, etc.), the relay device 30c, and the router 70c are interconnected via a LAN 2c for communicating with each other. The terminals (10da, 10db, 10dc, etc.), the relay device 30d, and the router 70d are interconnected via a LAN 2d for communicating with each other. In addition, the LAN 2c and the LAN 2d are connected via a designated line 2cd that employs a router 70cd for communicating with each other. The connections for communication are constituted inside a predetermined area B.

The terminals (10e1, 10e2, etc.) are interconnected via an Internet 21 for communicating with each other.

In addition, the management system 50 and the program-providing system 90 are connected to the terminal 10 and the relay device 30 via the Internet 21. The management system 50 and the program-providing system 90 may be located in the area A or in another area.

Further, the relay device 30e is connected to all of the terminals 10 in the transmission system 1 via the communication network 2. The relay device 30e is always in operation outside and located outside the area A and the area B in order to avoid to be affected by communication traffic in the local areas of the area A and the area B. Therefore, in a case where a terminal 10 calls a terminal 10 located in another local area, the relay device 30e is employed as a relay device for relaying call data. Furthermore, in a case where a relay device 30 located in a local area is not in operation at the time terminals 10 located in the same local area perform calling between each other, the relay device 30e is employed as a relay device for an emergency.

In the first embodiment, the communication network 2 includes the LAN 2a, the LAN 2b, the dedicated line 2ab, the Internet 21, the dedicated line 2cd, the LAN 2c, and the LAN 2d. The communication network 2 may include wired and/or wireless parts.

In FIG. 1, four digits indicated below each of the terminals 10, each of the relay devices 30, the management system 50, each of the routers 70, the program-providing system 90, and the maintenance system 100 are IP addresses of a general Internet Protocol version 4 (IPv4). For example, the IP address of the terminal 10aa is “1.2.1.3”. Although Ipv6 may be employed instead of Ipv4, Ipv4 is employed to make explanations simple.

<<Hardware Configuration of the First Embodiment>>

Next, a hardware configuration of the first embodiment will be described.

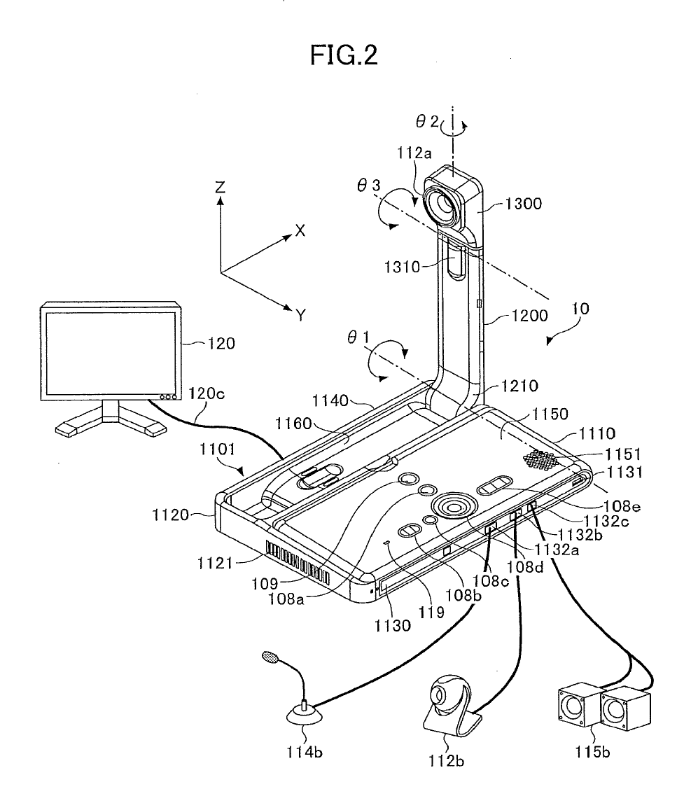

FIG. 2 is a schematic view of the terminal 10 according to the first embodiment. In the following explanation, the longitudinal direction of the terminal 10 is referred to as x-axis direction, a direction orthogonal to the x-axis direction on the horizontal surface is referred to as the y-axis direction, and a direction orthogonal to x-axis direction and y-axis direction (i.e. vertical direction) is referred to as z-axis direction.

As illustrated in FIG. 2, the terminal 10 includes a case 1101, an arm 1200, and a camera housing 1300. The front surface 1110 of the case 1101 has an air-intake part (not illustrated in FIG. 2) formed by multiple intake vent holes, whereas the rear surface 1120 of the case 1101 has an air-outlet part 1121 formed by multiple outlet vent holes. Here, when a cooling fan provided in the case 1101 is driven, the terminal 10 takes in air in the front through the air-intake part (not illustrated in FIG. 2), and exhausts air to the rear of the terminal 10 through the air-outlet part 1121. The right-side surface 1130 of the case 1101 has a sound collecting hole 1131 for collecting voice, other sound, noise, etc., through a built-in microphone 114a, which will be described hereinafter.

The case 1101 is provided with an operation panel 1150 by the right-side surface 113. The operation panel 1150 is provided with multiple operating buttons (108a through 108e), a power switch 109, and an alarm lamp, which will all be described hereinafter. Furthermore, the operation panel 1150 has a sound outlet part 1151 which is formed by multiple sound output holes to let output sound from a speaker 115a through. Further, the case 1101 is provided with an accommodating part 1160 by a left-side surface 1140, which serves as a recess to accommodate the arm 1200 and the camera housing 1300. Further, the case 1101 is provided with multiple connection ports (1132a through 1132c) by the right-side surface 1130 for electrically connecting cables to an external device connection interface (I/F) 118, which will be described hereinafter. On the other hand, the case 1101 is provided with a connection port (not illustrated in FIG. 2) by the left-side surface 1140 for electrically connecting a cable 120c for a display 120 to the external device connection I/F 118, which will be described hereinafter.

In the following explanation, an unspecified operation button among the operation buttons (108a through 108e) is simply referred to as an “operation button 108”, and an unspecified connection port among the connection ports (1132a through 1132c) is simply referred to a “connection port 1132”.

The arm 1200 is attached to the case 1101 by the intermediary of a torque hinge 1210, so as to be rotatable vertically in the range of a tilt angle θ1 of 0 through approximately 135 degrees. In FIG. 2, the tilt angle θ1 is at 90 degrees.

The camera housing 1300 is provided with a built-in camera 112a, which will be described hereinafter, so as to capture images of a user, documents, a room, etc. Further, the camera housing 1300 is provided with a torque hinge 1310. The camera housing 1300 is attached to the arm 1200 by the intermediary of the torque hinge 1310, so as to be rotatable vertically and horizontally in the range of a pan angle θ2 of ±180 degrees and in the range of a tilt angle θ3 of ±45 degrees, supposing that the angles are 0 in the state illustrated in FIG. 2.

In addition, an external camera 112b, an external microphone 114b, an external speaker, etc., are connected through a universal serial bus (USB), etc., to a terminal 10 that concurrently connects to multiple sessions, which will be described hereinafter.

External views of the relay device 30, the management system 50, the program-providing system 90, and the maintenance system 100 are the same as an external view of a general server computer, and therefore an explanation will be omitted.

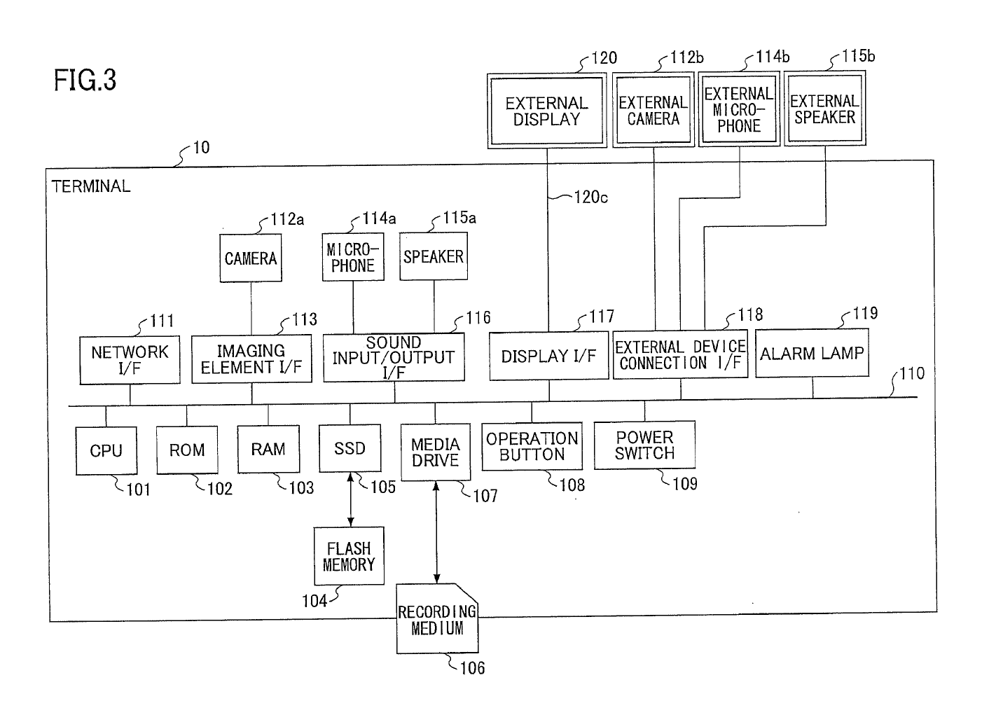

FIG. 3 is a diagram illustrating a hardware configuration of the terminal 10 according to the first embodiment of the present invention. As illustrated in FIG. 3, the terminal 10 according to the first embodiment includes a central processing unit (CPU) 101 that controls overall operation of the terminal 10, a read-only memory (ROM) 102 that stores programs executed on the terminal 10, a random access memory (RAM) 103 used as a work area for the CPU 101, a flash memory 104 that stores various types of data such as image data and sound data, a solid state drive (SSD) 105 that controls read/write processing of various types of data from/to the flash memory 104 in accordance with control, of the CPU 101, a medium drive 107 that controls read/write (storage) processing of data from/to a recording medium 106 such as a flash memory 104, the operation button 108 that is operated when, for example, selecting a counterpart-terminal of the terminal 10, a power switch 109 for turning on and off the power of the terminal 10, and a network I/F 111 for transmitting data via the communication network 2.

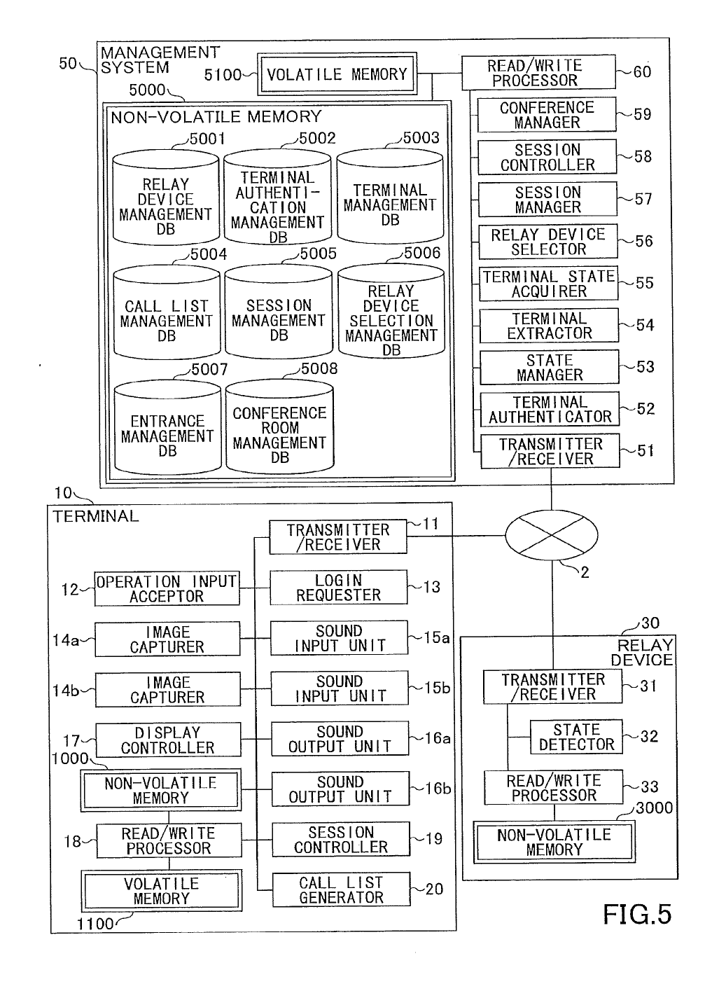

Furthermore, the terminal 10 includes the built-in camera 112a that captures an image of an object and obtains image data in accordance with control of the CPU 101, an imaging element I/F 113 that controls driving of the camera 112a, the built-in speaker 115a that outputs sound, a sound input/output I/F 116 that perform input/output processing of sound signals between the built-in microphone 114a and the speaker 115a in accordance with control of the CPU 101, a display I/F 117 that transmits image data to an external display 120 in accordance with control of the CPU 101, the external device connection I/F 118 that is provided on each of the connection ports 1132a through 1132c illustrated in FIG. 2 for connecting various types of external devices, an alarm lamp 119 that alarms for informing of problems of functions of the terminal 10, and a bus line 110 such as an address bus and a data bus for electrically connecting the above-described elements, as illustrated in FIG. 5.

The display 120 is a display unit constituted by liquid crystal, organic electroluminescence (EL), etc., for displaying images of objects, operation icons, etc. Further, the display 120 is connected to the display I/F 117 via the cable 120c. The cable 120C may be an analog red green blue (RGB) (video graphic array (VGA)) signal cable, a component video cable, a high-definition multimedia interface (HDMI, registered trademark) signal cable, or a digital video interactive (DVI) signal cable.

The camera 112a includes a lens and a solid-state imaging element that converts light to electric charge in order to digitize an image (video) of an object to electronic data. The solid-state imaging element may be, for example, a complementary metal-oxide-semiconductor (CMOS), a charge-coupled device (CCD), etc.

The external device connection I/F 118 is capable of connecting to an external device such as an external camera 112b, an external microphone 114b, or an external speaker 115b via a USB cable, etc.

Here, the recording medium 106 is removable from the terminal 10. Further, the recording medium 106 is not limited to the flash memory 104 as far as the recording medium 106 is a non-volatile memory on which read/write processing of data is performed in accordance with control of the CPU 101. Here, the recording medium 106 may be an electrically erasable and programmable ROM (EEPROM), etc.

Further, the terminal-oriented programs may be recorded on a computer-readable recording medium such as the recording medium 106 as installable or executable format files, so as to be distributed.

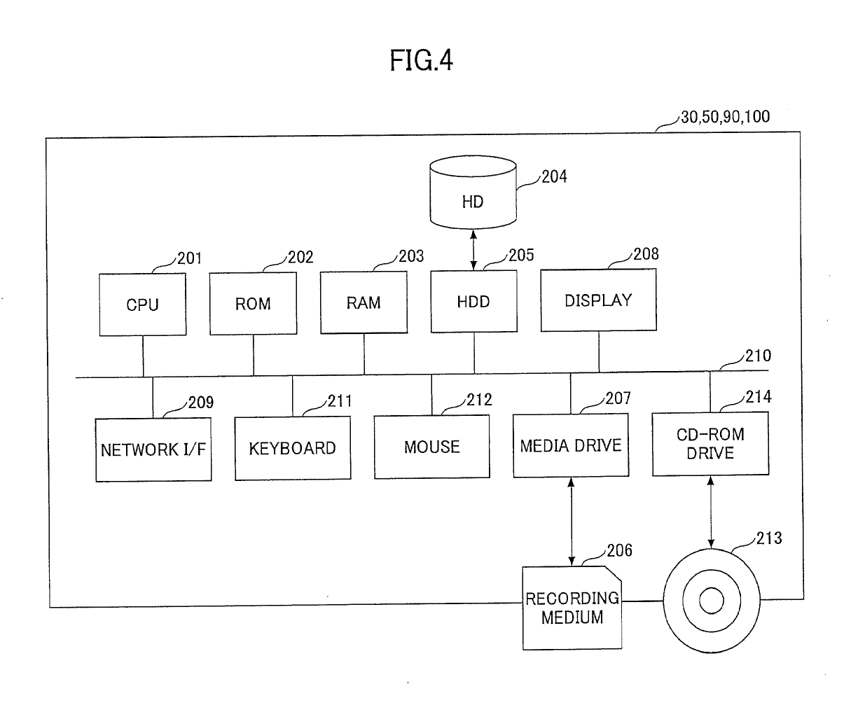

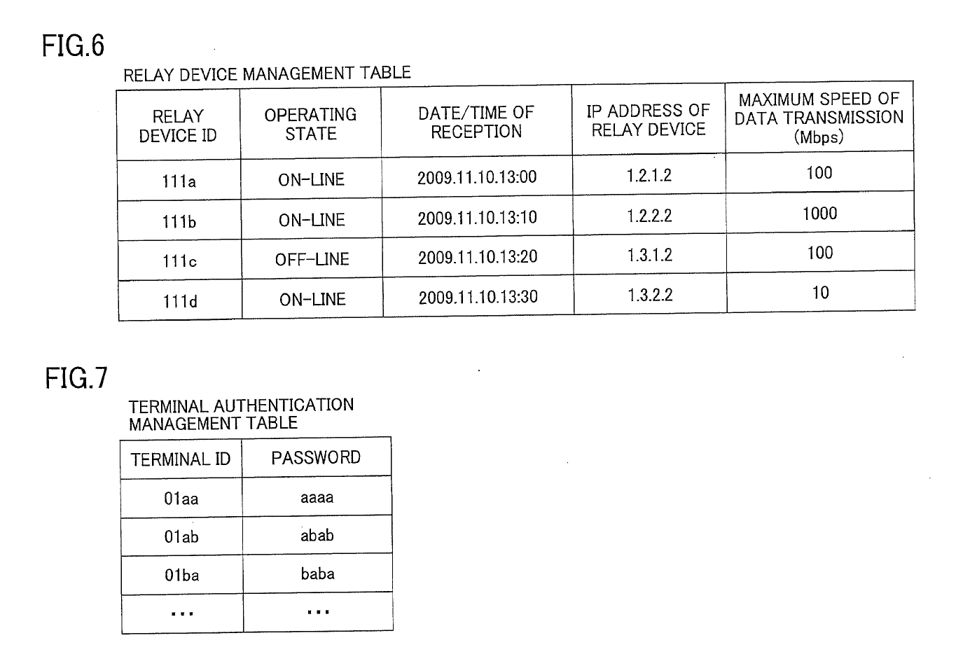

FIG. 4 is a diagram illustrating a hardware configuration of the management system 50 according to the embodiment of the present invention. The management system 50 includes a CPU 201 that controls overall operation of the management system 50, a ROM 202 that stores programs for transmission management, a RAM 203 used as a work area for the CPU 201, the HD 204 that stores various types of data, a hard disk drive (HDD) 205 that controls read/write processing of various types of data from/to the HD 204 in accordance with control of the CPU 201, a media drive 207 that controls read/write (storage) processing of data from/to a recording medium 206 such as a flash memory, a display 208 that displays various types of information such as a cursor, a menu, a window, a character, or an image, a network I/F 209 for transmitting data via the communication network 2, a keyboard 211 having multiple keys for entering characters, numerical number, and various instructions, a mouse 212 for selecting and executing various instructions, selecting an object for processing, and moving the cursor, a compact disc ROM (CD-ROM) drive 214 that controls read/write processing of various types of data from/to a removable recording medium such as a CD-ROM 213, and a bus line 210, such as an address bus and a data bus, for electrically connecting the above-described elements, as illustrated in FIG. 6.

Here, the programs for transmission management may be recorded on a computer-readable recording medium such as the recording medium 206 and the CD-ROM 213 as installable or executable format files, so as to be distributed.

The hardware configuration of the relay device 30 is the same as the hardware configuration of the management system 50, and therefore an explanation will be omitted, although the ROM 202 stores relay device-oriented programs for controlling the relay devices 30. Here, the relay device-oriented programs may be recorded on a computer-readable recording medium such as the recording medium 206 and the CD-ROM 213 as installable or executable format files, so as to be distributed.

Further, the hardware configuration of the program-providing system 90 is the same as the hardware configuration of the management system 50, and therefore an explanation will be omitted, although the ROM 202 stores programs for program-providing for controlling the program-providing system 90. Here, the relay device-oriented programs may be recorded on a computer-readable recording medium such as the recording medium 206 and the CD-ROM 213 as installable or executable format files, so as to be distributed.

Further, the hardware configuration of the maintenance system 100 is the same as the hardware configuration of the management system 50, and therefore an explanation will be omitted, although the ROM 20.2 stores maintenance programs for controlling the maintenance system 100. Here, the relay device-oriented programs may be recorded on a computer-readable recording medium such as the recording medium 206 and the CD-ROM 213 as installable or executable format files, so as to be distributed.

Here, examples of the removable recording medium are computer-readable recording mediums such as a compact disc recordable (CD-R), a digital versatile disk (DVD), and a Blu-ray disk.

<<Functional Configuration of the First Embodiment>>

Next, the functional configuration of the first embodiment will be described. FIG. 5 is a functional block diagram of the terminal 10, the relay device 30, and the management system 50 included in the transmission system 1 according to the first embodiment. In FIG. 5, the terminal 10, the relay device 30, and the management system 50 are interconnected so as to perform data communication via the communication network 2. Here, the program-providing system 90 and the maintenance system 100 are not illustrated in FIG. 5 as the program-providing system 90 and the maintenance system 100 are not directly involved in teleconference communication.

<Functional Configuration of the Terminal>

The terminal 10 includes a transmitter/receiver 11, an operation input acceptor 12, a login requester 13, image capturers 14a and 14b, sound input units 15a and 15b, sound output units 16a and 16b, a display controller 17, a read/write processor 18, a session controller 19, and an call list generator 20. The functions of the respective parts are implemented in an event that respective constituent elements illustrated in FIG. 3 are operated in accordance with instructions of the CPU 101 based on the programs stored in the ROM 102. Further, the terminal 10 includes a volatile memory 1100 constituted by the RAM 103 illustrated in FIG. 3 and a non-volatile memory 1000 constituted by the flash memory 104 illustrated in FIG. 3.

<Functional Parts of the Terminal 10>

In the following, each part of the terminal 10 will be described in detail.

The transmitter/receiver 11, which is embodied by the network I/F 111 illustrated in FIG. 3, receives and transmits various types of data with other terminals, devices, and systems via the communication network 2. The transmitter/receiver 11 starts receiving state-information that indicates the state of respective potential counterpart-terminals 10 from the management system 50, before starting communication with a desired counterpart-terminal 10. The state-information indicates not only operating state of respective terminals 10 (either online or offline), but also detailed state such as whether an online terminal 10 is currently in communication with another terminal 10 or is ready for calling another terminal. Further, the state-information indicates not only operating state of respective terminals 10, but also various kinds of state where, for example, a cable is disconnected from the terminal 10, the terminal 10 outputs sound but not images, or the terminal 10 does not output sound (i.e. mute), etc. In the following explanation, the state-information indicates operating state.

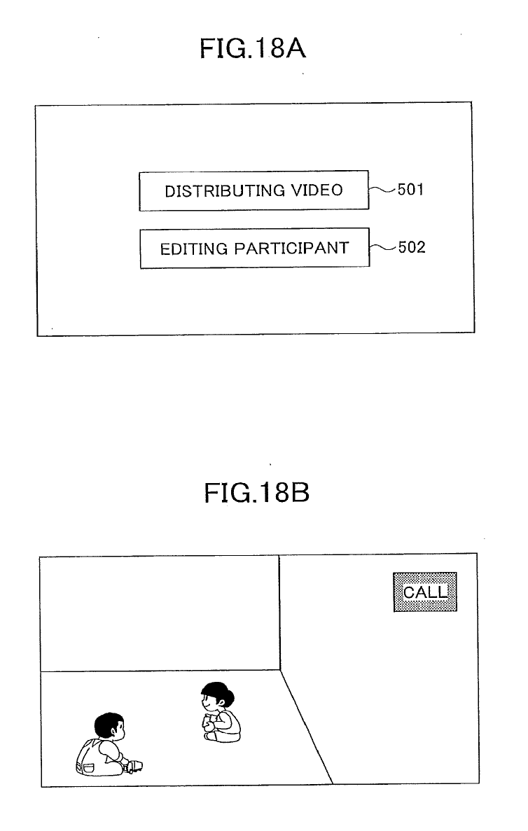

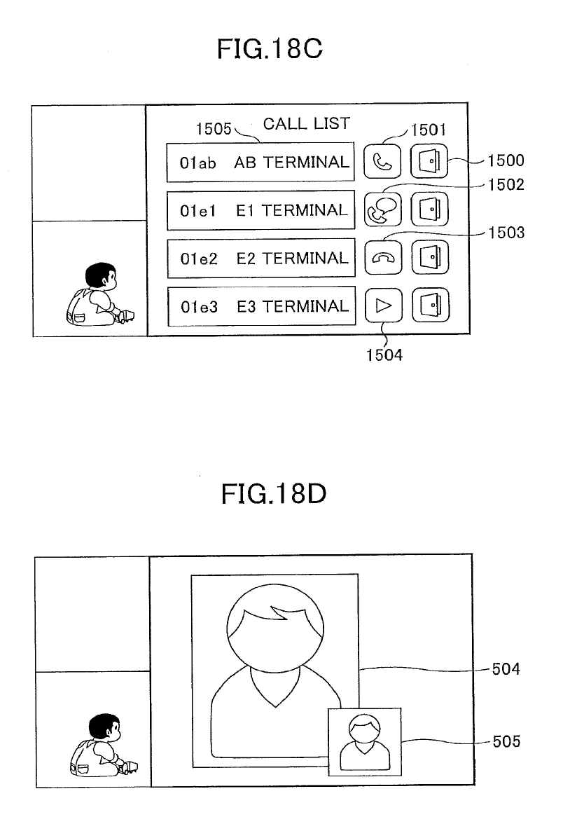

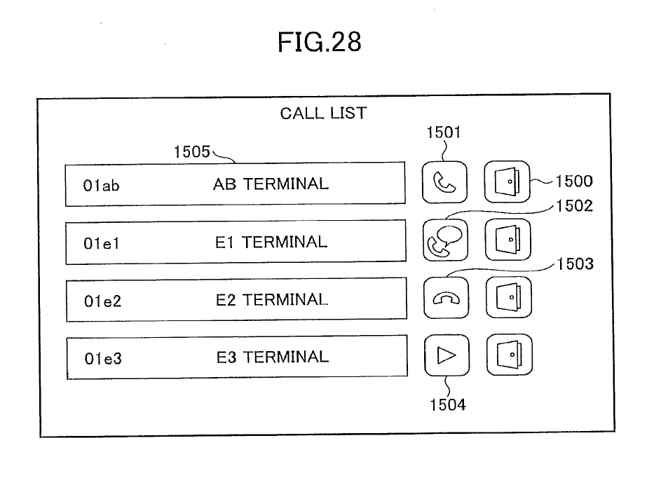

Here is an explanation of various types of data which is transmitted and received among other terminals, devices, and systems, via the communication network 2. For example, the transmitter/receiver 11 transmits start-request information to the management system 50, when starting communication with a counterpart-terminal selected by a user from a later-described counterpart-terminal state listing image (illustrated in FIG. 18C and FIG. 28). The start-request information includes start-request information based on regular call and start-request information based on entering call (i.e. distribution).

The start-request information based on regular call is transmitted when a terminal 10 requests to start communication that is available to the terminal 10 (hereinafter referred to as “calling-communication”). The start-request information based on regular call includes a terminal ID for identifying the requestor-terminal, a terminal ID for identifying the counterpart-terminal, and information “invite”, which is indicative of a request for starting conversation over the calling-communication.

The start-request information based on entering call is transmitted when a terminal 10 requests to start a conference that is performed over communication available to one or more predetermined terminals 10 (hereinafter referred to as “distribution-communication”). The start-request information based on entering call includes a terminal ID for identifying the requestor-terminal, a terminal ID for identifying the counterpart-terminal, and information “Invite+Room”, which is indicative of a request for starting conversation over the distribution-communication. The conference performed over the distribution-communication is identified by a conference room ID. Here, the start-request information based on entering call may include a conference room ID instead of the terminal ID, so that the distribution-communication is identified by the start-request information based on entering call. In such a way, a later-described conference manager 59 provided in the management system 50 may skip a process of searching a later-described entrance management DB 5007 using the terminal ID of the counterpart-terminal 10 as a search key and acquiring a conference room ID out of the searched records so as to specify a conference room to be used for communication.

After transmitting the start-request information to the management system 50, the transmitter/receiver 11 receives, from the management system 50, relay device connecting information and a session ID for specifying communication. The relay device connecting information is information that is necessary for connecting to the relay device 30 to be used for the communication, which is exemplified as an IP address and a port number of the relay device 30, authentication information for connecting to the relay device 30, etc.

Further, the transmitter/receiver 11 receives starting response information from the management system 50. The starting response information indicates whether the communication with the counterpart-terminal is available. The starting response information includes a terminal ID of the counterpart-terminal, information indicating whether to accept or reject starting the communication, and the ID session for identifying the communication. Upon receiving from the management system 50 starting response information that indicates that the communication with the counterpart-terminal is accepted, the transmitter/receiver 11 transmits the session ID of the communication and the relay device connecting information to the relay device 30.

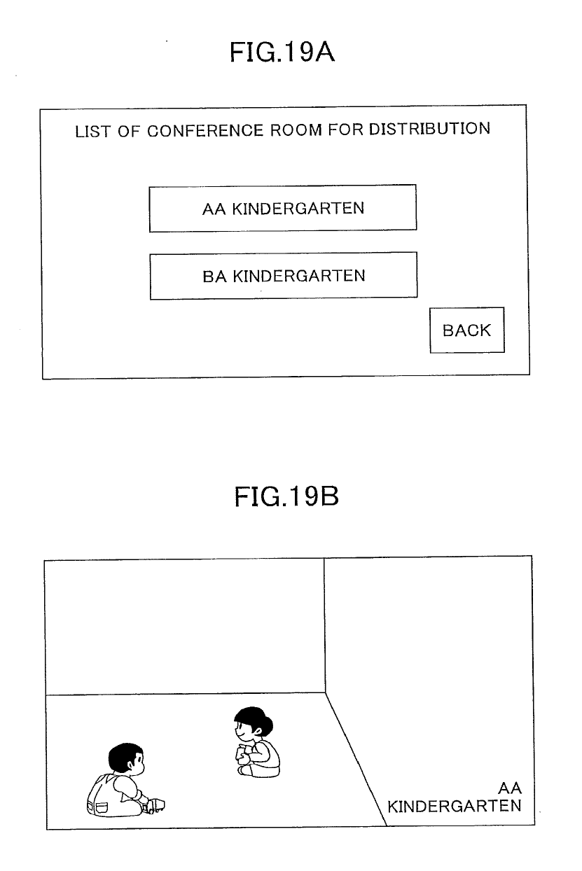

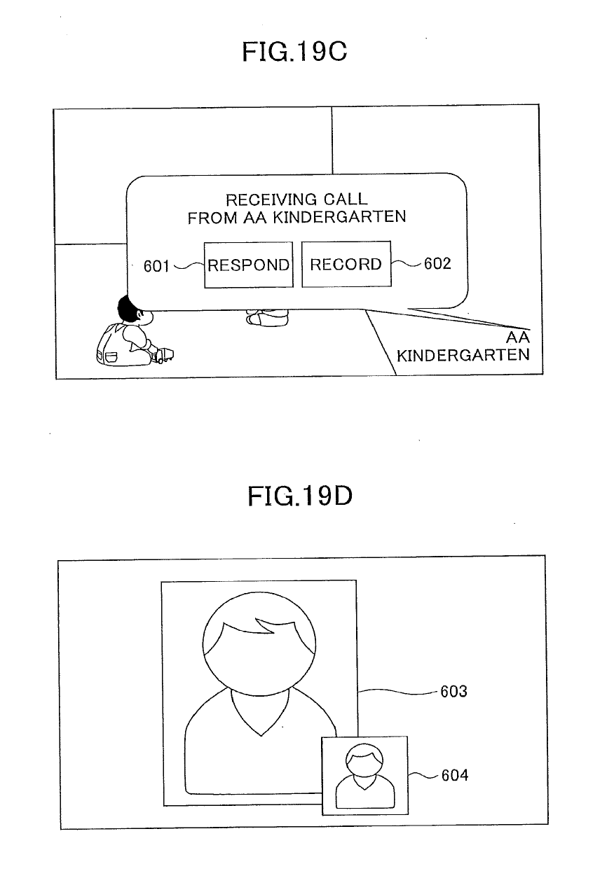

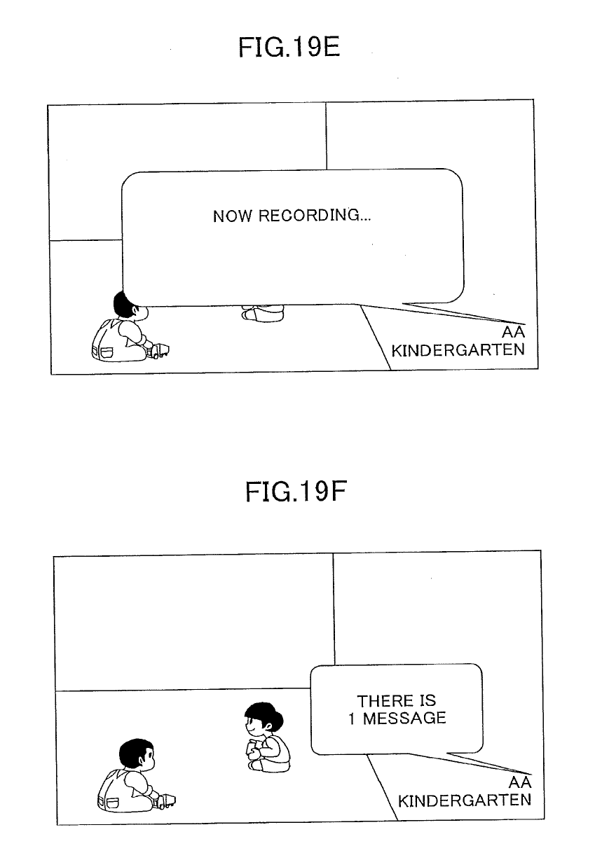

Further, the transmitter/receiver 11 transmits an entering request to the management system 50, when a user selects a conference room (or conference name) based on a later-described conference room listing image (illustrated in FIG. 19A) for starting communication. The entering request includes the terminal ID of the requestor-terminal, the conference room ID of the conference room, and information “Invite+Room”, which indicates to request for starting communication over the distribution-communication.

The operation input acceptor 12, which is embodied by the operation button 108 and the power switch 109 illustrated in FIG. 3, accepts input from a user. For example, when the user turns on the power switch 109 illustrated in FIG. 3, the operation input acceptor 12 illustrated in FIG. 5 accepts the operation of turning on the power, and then turns on the power. Further, upon accepting operation of selecting a counterpart-terminal out of a later-described counterpart-terminal state listing image (illustrated in FIG. 28), the operation input acceptor 12 requests the transmitter/receiver 11 to transmit to the management system 50 start-request information based on entering call or start-request information based on regular call. Further, upon accepting operation of selecting a conference room out of a later-described conference room listing image (illustrated in FIG. 19A), the operation input acceptor 12 requests the transmitter/receiver 11 to transmit to the management system 50 an entering request.

Upon accepting the operation of turning on the power, the login requester 13, which is embodied by the CPU 101 illustrated in FIG. 3, automatically transmits login-request information that is indicative of a request for authentication (login) and a current IP address of the requestor-terminal 10, through the transmitter/receiver 11 to the management system 50 via the communication network 2. The login-request information includes the terminal ID for identifying the requestor-terminal 10 itself and a password to login to the transmission system 1. Further, when a user turns off the power switch 109, the transmitter/receiver 11 transmits to the management system 50 state-information that indicates the power is turned off, and then the operation input acceptor 12 completely turns off the power. In such a way, the management system 50 is aware that the power of the terminal 10 is turned off.

The image capturer 14a, which is embodied by operation of the CPU 101, the camera 112a, and the imaging element I/F 113, illustrated in FIG. 3, captures an object to output acquired image data. The sound input unit 15a, which is embodied by the sound input/output I/F 116 illustrated in FIG. 3, inputs sound data obtained from sound signals that are converted from voice of a user by the built-in microphone 114a. The sound output unit 16a, which is embodied by operation of the CPU 101 and the sound input/output I/F 116 illustrated in FIG. 3, outputs sound signals obtained from sound data to the speaker 115a, so that sound is output from the speaker 115a.

The image capturer 14b, which is embodied by operation of the CPU 101 and the external camera 112b illustrated in FIG. 3, captures an object to output acquired image data. The sound input unit 15b inputs sound data obtained from sound signals that are converted from voice of a user by the external microphone 114b. The sound output unit 16b, which is embodied by operation of the CPU 101 illustrated in FIG. 3, outputs sound signals obtained from sound data to the external speaker 115.b, so that sound is output from the external speaker 115b.

The display controller 17, which is embodied by operation of the CPU 101 illustrated in FIG. 3, controls displaying of image data on the external display 120. For example, the display controller 17 controls displaying of the later-described counterpart-terminal state listing image (illustrated in FIG. 18C and FIG. 28) and the later-described conference room listing image (illustrated in FIG. 19) on the display 120.

The read/write processor 18, which is embodied by the CPU 101 illustrated in FIG. 3 and the SSD 105 as exemplified in FIG. 3, performs read/write processing of various types of data from/to the non-volatile memory 1000. The non-volatile memory 1000 stores terminal IDs for identifying respective terminals 10, passwords, etc. Further, the read/write processor 18 performs read/write processing of various types of data from/to the volatile memory 1100. In the volatile memory 1100, image data and sound data received during communication with a counterpart-terminal is continuously overwritten. Here, displaying an image on the display 120 is based on the last image data before overwritten and outputting sound from the speaker 115a is based on the last sound data before overwritten.

The session controller 19 performs connecting to a call-session (an example of a “first session”), in which a conversation with another terminal 10 is performed, and to a distribution-session (an example of a “second session”), in which sound data is transmitted to multiple other terminals 10.

The session controller 19 stops transmitting sound data over the distribution-session, in a case of connecting to a call-session while connected to the distribution-session. For example, the session controller 19 stores state and types of sessions, so that, upon detecting an awaiting connection of a call-session while connected to a distribution-session or upon receiving an sound distribution-stop request from the management system 50, the session controller 19 puts the microphone for distribution on mute or removes sound data from the distribution-session, which prevents an acoustic feedback and leaking of private conversation to users of the terminals 10 on the distribution-session.

In an event that a call-session cannot be connected or that a recording request is received from a counterpart-terminal 10 of the call-session, the session controller 19 records content data such as video and sound, so that the transmitter/receiver 11 transmits the recorded content data to the counterpart-terminal 10 of the call-session through the management system 50.

The session controller 19 exits a distribution-session in an event that the session controller 19 responds, in accordance with a user operation, etc., to a received request for connecting to a call-session while content is distributed over the distribution-session, or in an event that the session controller 19 receives a request for exiting (leaving) the distribution-session from the management system 50.

Here, the terminal ID and a later-described relay device ID according to the first embodiment are identification information for identifying the terminal 10 and the relay device 30. Further, the identification information may be a word, a letter, a sign, a mark, etc. Further, the terminal ID and the relay device ID may be a combination of two or more of such a word, a letter, a sign, a mark, etc. Here, the same is true of the session ID and the conference room ID.

The call list generator 20 generates a call list (counterpart-terminal state listing information) based on information of later-described “multiple sessions allowance flag”, call list information, state-information, and conference room existence information.

The call list generator 20 generates a call list that implies that calling cannot be done to a counterpart-terminal 10 which is, according to the operating state, unable to receive a call. For example, the call list generator 20 generates a list on which a button to call a terminal 10 whose operating state is “ON-LINE (DURING CALL)” or “OFF-LINE” cannot be pressed, whereas a button to call a terminal 10 whose operating state is “ON-LINE (READY FOR CALL)” or “ON-LINE (DURING DISTRIBUTION)” can be pressed.

The call list generator 20 generates a call list that implies that calling cannot be done to a counterpart-terminal 10 in a case where the terminal 10 is not capable of connecting to multiple sessions at the same time and the terminal 10 is connected to either a distributing or a call-session. Specifically, the terminal 10 is determined not to be capable of connecting to multiple sessions at the same time in a case where the information of “MULTIPLE SESSION ALLOWANCE FLAG” transmitted from the management system 50 is not ON.

The call list generator 20 displays the generated call list on the screen through the display controller 17 (as illustrated in FIG. 18C and FIG. 28).

(Functional Configuration of the Relay Device)

The relay device 30 includes a transmitter/receiver 31, a state detector 32, a read/write processor 33. The functions of the respective parts are implemented in an event that respective constituent elements illustrated in FIG. 3 are operated in accordance with instructions of the CPU 201 based on the programs stored in the ROM 202. Further, the relay device 30 includes a non-volatile memory 3000 constituted by the HD 204 illustrated in FIG. 4 that is capable of storing various types of data and information even though the power of the relay device 30 is turned off.

In the following, functional configuration of the relay device 30 will be described in detail. Here, along with explanations of respective parts of the relay device 30, relationships with major Constituent elements illustrated in FIG. 4 which embodies respective parts of the relay device 30 will be described.

The transmitter/receiver 31 provided in the relay device 30 illustrated in FIG. 5, which is embodied by the network I/F 209 illustrated in FIG. 4, receives and transmits various types of data (or information) from/to other terminals, devices, and systems via the communication network 2. For example, the transmitter/receiver 31 receives a session ID and relay device connecting information from the terminal 10.

The state detector 32, which is embodied by operation of the CPU 201 illustrated in FIG. 4, detects operating state of the relay device 30 in which the state detector 32 itself is provided. The operating state includes “ON-LINE”, “OFF-LINE”, and “OUT OF ORDER”. The state detector 32 transmits operating state to the management system 50 through the transmitter/receiver 31.

The read/write processor 33 performs read/write processing of various types of data from/to a non-volatile memory 3000.

<Functional Configuration of the Management System>

In the following, the functions and units of the management system 50 will be described. First, information stored in the management system 50 will be explained. The management system 50, which is constituted by the HD 204 illustrated in FIG. 4, includes a non-volatile memory 5000 which is capable of storing various types of data and information even though the power of the management system 50 is turned off. Furthermore, the management system 50 includes a volatile memory 5100 which is constituted by the RAM 203 illustrated in FIG. 4.

(Relay Device Management Table)

The non-volatile memory 5000 includes a relay device management DB 5001 constituted by a relay device management table illustrated in FIG. 6. The relay device management table manages, in association with respective relay device IDS of the relay devices 30, the operating state of the relay devices 30, the date/time when state-information that indicate the operating state are received by the management system 50, IP addresses of the relay devices 30, and the maximum speed of data transmission (Mbps) performed by the relay devices 30. For example, the relay device management table illustrated in FIG. 6 indicates that the operating status of the relay device 30a whose the relay device ID is “111a” is “ON-LINE”, the date/time when state-information is received by the management system 50 is “Nov., 10, 2009, 13:00”, the IP address of the relay device 30a is “1.2.1.2”, and the maximum speed of data transmission is “100 Mbps”.

(Terminal Authentication Management Table)

The non-volatile memory 5000 includes a terminal authentication management DB 5002 constituted by a terminal authentication management table illustrated in FIG. 7. The terminal authentication management table manages, in association with respective terminal IDs of all of the terminals 10 managed by the management system 50, passwords for login to the transmission system 1. For example, the terminal authentication management table illustrated in FIG. 7 indicates that the terminal ID of the terminal 10aa is “01aa” and the password is “aaaa”. The information of the terminal authentication management table is registered by a user or an administrator of the management system 50 in advance.

(Terminal Management Table)

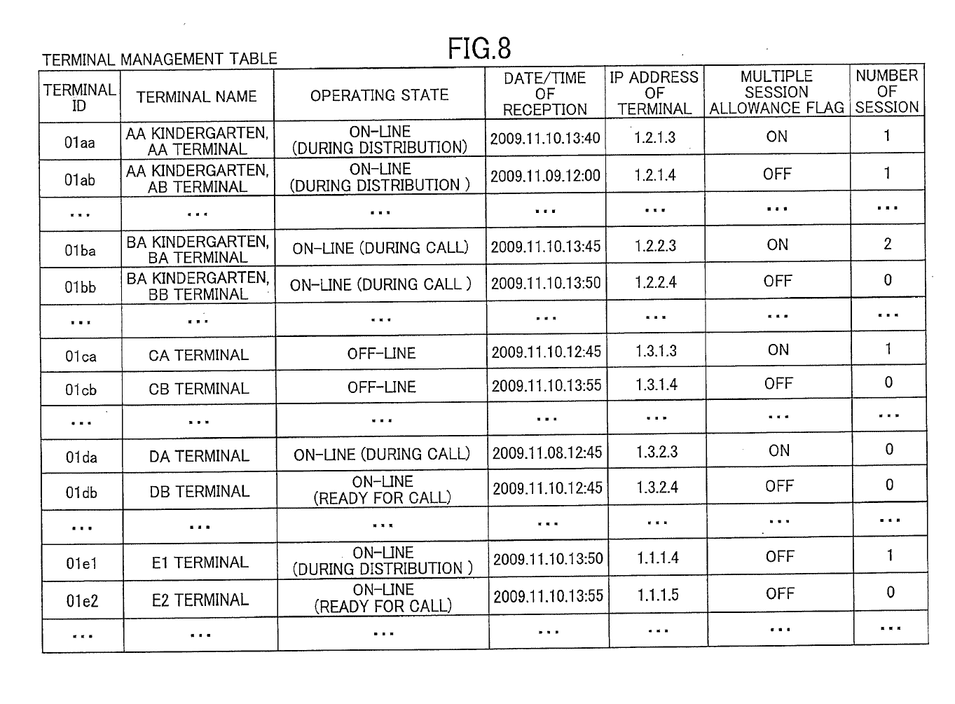

The non-volatile memory 5000 includes a terminal management DB 5003 constituted by a terminal management table illustrated in FIG. 8. The terminal management table manages, in association with respective terminal IDs of the terminals 10, terminal names, operating state of the terminals 10, date/time when the login-request information is received by the management system 50, IP addresses of the terminals 10, multiple session allowance flags which indicates whether to be capable of connecting to multiple sessions at the same time, and the number of sessions which indicates the number of currently connected sessions. For example, the terminal management table illustrated in FIG. 8 indicates that the terminal ID of the terminal 10aa is “01aa”, the terminal name of terminal 10aa is “AA kindergarten, AA terminal”, the operating state of the terminal 10aa is “ON-LINE (READY FOR CALL)”, the time/data when the login-request information is received by the management system 50 is “Nov. 10, 2009, 13:40”, and the IP address of the terminal 10aa is “1.2.1.3”.

(Call List Management Table)

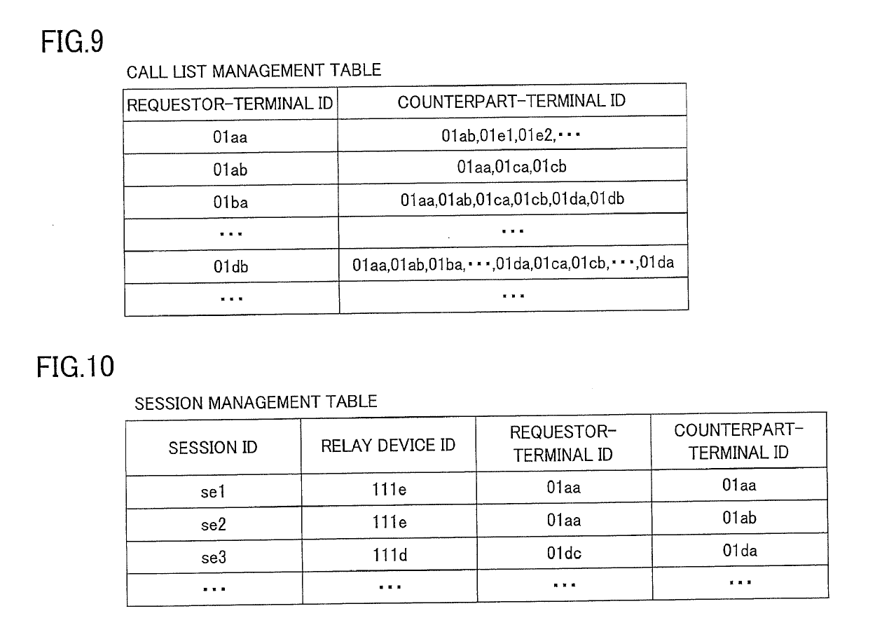

The non-volatile memory 5000 includes a call list management DB 5004 constituted by a call list management counterpart-terminal table illustrated in FIG. 9. The call list management counterpart-terminal table manages Counterpart-terminal IDs, in association with respective requestor-terminal IDs. The requestor-terminal ID are information for identifying requestor-terminal s which request for starting communication. The counterpart-terminal IDs are information for identifying the potential counterpart-terminals of communication which the requestor-terminals request to start. Potential counterpart-terminals may be added or deleted in an event that the management system 50 receives a request from a requestor-terminal. For example, the call list management counterpart-terminal table illustrated in FIG. 9 indicates that the potential counterpart-terminals to which the requestor-terminal (i.e. terminal 10aa) whose terminal ID is “01aa” may request for starting teleconferencing communication is terminal 10ab whose terminal ID is “01ab”, terminal 10ba whose terminal ID is “01ba”, terminal 10bb whose terminal ID is “01bb”, terminal 10ca whose terminal ID is “01ca”, and terminal 10db whose terminal ID is “01db”.

(Session Management Table)

The non-volatile memory 5000 includes a session management DB 5005 constituted by a session management table illustrated in FIG. 10. The session management table manages, in association with respective session IDs for identifying communication between terminals, the relay device IDs of the relay device 30 employed for relaying image data and sound data, the terminal IDs of the requestor-terminals, and the terminal ID of the counterpart-terminals. Here, in a case where a terminal ID of a reguestor-terminal and a terminal ID of a counterpart-terminal are the same, it is indicated that there is a session in which the requestor-terminal distributes image data and sound data but there have been no terminals. 10 which receive distribution. For example, the session management table illustrated in FIG. 10 indicates that the relay device 30e (relay device ID “111e”) assigned to a session with a session ID of “se1” is distributing image and sound data to the requestor-terminal (terminal 10aa) with the terminal ID of “01aa”, and that the relay device 30e (relay device ID “111e”) assigned to another session with a session ID of “se2” is relaying image and sound data in-between the requestor-terminal (terminal 10aa) with the terminal ID of “01aa” and the counterpart-terminal (terminal 10ab) with the terminal ID of “01ab”.

(Relay Device Selection Management Table)

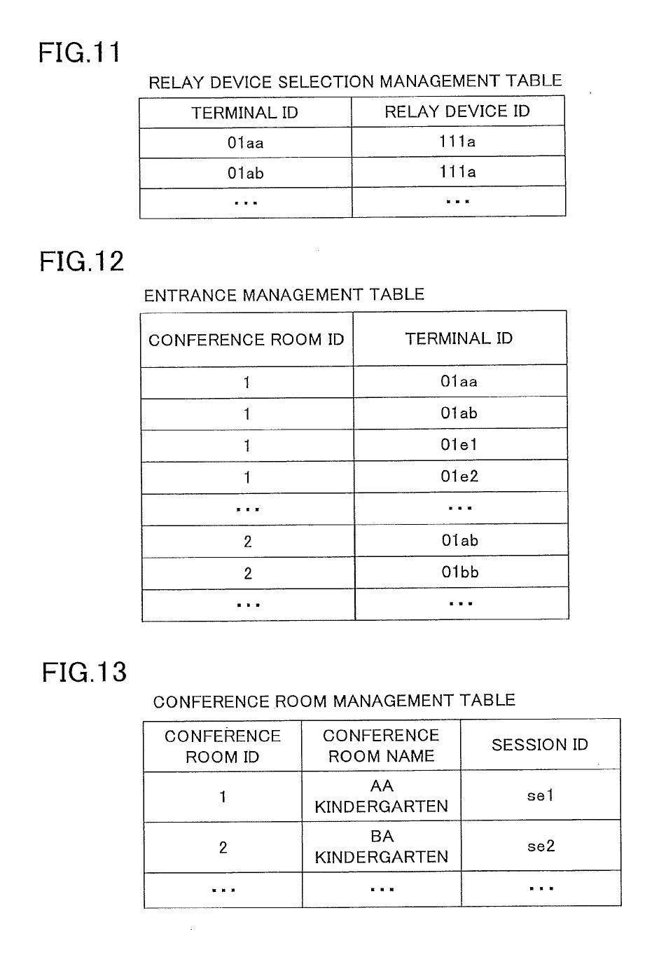

The non-volatile memory 5000 includes a relay device selection management DB 5006 constituted by a relay device selection management table illustrated in FIG. 11. The relay device selection management table manages, in association with respective terminal IDs of all of the terminals 10 managed by the management system 50, the relay device IDs of the relay device 30 employed for distributing image and sound data.

(Entrance Management Table)

The non-volatile memory 5000 includes an entrance management DB 5007 constituted by an entrance management table illustrated in FIG. 12. The entrance management table manages, in association with respective conferences (distributions) performed over distribution-communication available to one or more predetermined terminals 10, conference room IDs for identifying conferences and terminal IDs of the one or more predetermined terminals 10. Here, in the example of FIG. 12, it is indicated that content data is distributed from the terminal listed on the top (terminal ID “01aa”) to other terminals (terminal IDs “01ab”, “01e1”, “01e2”, etc.).

(Conference Room Management Table)

The non-volatile memory 5000 includes a conference room management DB 5008 constituted by a conference room management table illustrated in FIG. 13. The conference room management table manages, in association with respective conferences (distributions) performed over distribution-communication available to one or more predetermined terminals 10, conference room IDs for identifying conferences, conference names, and session IDs of distribution-communication identified by the conference room IDs. The conference room IDs are information for identifying virtually generated conference rooms or conferences to be held.

(Functional Parts of the Management System)

In the following, functional parts of the management system 50 will be described. Here, along with explanations of respective parts of the management system 50, relationships with major constituent elements illustrated in FIG. 4 which embodies respective parts of the management system 50 will be described as well. The management system 50 includes a transmitter/receiver 51, a terminal authenticator 52, a state manager 53, a terminal extractor 54, a terminal state acquirer SS, a relay device selector 56, a session manager 57, a session controller 58, a conference manager 59, and a read/write processor 60. The functions of the respective parts are implemented in an event that respective constituent elements illustrated in FIG. 4 are operated in accordance with instructions of the CPU 201 based on the programs stored in the ROM 202.

The transmitter/receiver 51, which is embodied by the network I/F 209 illustrated in FIG. 4, receives and transmits various types of data from/to other terminals, devices, and systems through the communication network 2.

For example, the transmitter/receiver 51 receives a start-request information of entering call or a start-request information of regular call, when starting communication with a counterpart-terminal selected by a user of the terminal from a later-described counterpart-terminal state listing image (illustrated in FIG. 18C and FIG. 28).

Further, after receiving start-request information from the terminal 10, the transmitter/receiver 51 transmits a relay device connecting information and a session ID for identifying communication to the terminal 10.

Further, after receiving start-request information from a terminal 10 that is a requestor of communication, the transmitter/receiver 51 transmits the start-request information, the relay device connecting information, and the IP address of a management system 50 to the terminal 10 requesting for the communication.

Further, after receiving starting response information from a counterpart-terminal 10 of communication, the transmitter/receiver 51 transmits the starting response information to the requestor-terminal 10 of the communication.

The terminal authenticator 52 searches the terminal authentication management table (illustrated in FIG. 7) of the non-volatile memory 5000 by use of a terminal ID and a password obtained from login-request information received through the transmitter/receiver 51 as search keys, and then determines whether the same terminal ID and password are managed in the terminal authentication management table, so as to perform authentication of the terminal.

For the purpose of managing the operation state of a terminal that transmits a login request, the state manager 53 manages, in the terminal management table (illustrated in FIG. 8), the terminal ID of the requestor-terminal, the name of the requestor-terminal, the operating state of the requestor-terminal, the time/date when the login-request information is received by the management system 50, and the IP address of the requestor-terminal, in association with each other.

Here, upon receiving information indicating that the state of the terminal 10 is changed from the terminal 10, the state manager 53 performs (changes) the setting of the state-information of the terminal 10 on the terminal management table (illustrated in FIG. 8). For example, in an event that the user of the terminal 10 turns on the power switch 109, the terminal 10 transmits state-information indicating that the power is turned on to the management system 50. Upon receiving the state-information through the transmitter/receiver 51, the state manager 53 changes the operating state of the terminal 10 on the terminal management table (illustrated in FIG. 8) from “OFF-LINE” to “ON-LINE (READY FOR CALL)”. Further, in an event that the user of the terminal 10 turns off the power switch 109, the terminal 10 transmits state-information indicating that the power is turned off to the management system 50. Upon receiving the state-information through the transmitter/receiver 51, the state manager 53 changes the operating state of the terminal 10 on the terminal management table (illustrated in FIG. 8) from “ON-LINE (READY FOR CALL)” to “OFF-LINE”.

Upon receiving information indicating that the state of the terminal 10 is changed from the terminal 10, the state manager 53 informs counterpart-terminals of the terminal 10 of the change of the operating state. In such a way, the operating state of the terminal 10 is updated on the counterpart-terminal state listing image (illustrated in FIG. 18C and FIG. 28) which is displayed on the counterpart-terminals of the terminal 10.

Specifically, the state manager 53 searches the call list management table (illustrated in FIG. 9) for terminal IDs of the counterpart-terminals by use of the terminal ID of the terminal 10 whose state has been changed as a search key, in order to extract the counterpart-terminals of the terminal 10 whose state has been changed. Then, the state manager 53 informs the extracted terminals of the change of the state of the terminal 10.

The terminal extractor 54 searches the call list management table (illustrated in FIG. 9) for a terminal 10 that has transmitted a login request by use of the terminal ID of the terminal 10 that has transmitted the login request, in order to extract the terminal ID of the counterpart-terminals of the searched records. The terminal extractor 54 further extracts terminals 10 identified by the extracted terminal ID of the counterpart-terminals as potential counterpart-terminals for communication with the requestor-terminal 10.

The terminal state acquirer 55 searches the terminal management table (illustrated in FIG. 8) IDs by use of each of the terminal IDs of the potential counterpart-terminals extracted by the terminal extractor 54 as search keys, in order to retrieve operating state of the searched records. In such a way, the terminal state acquirer 55 acquires operating state of the potential counterpart-terminals for communicating with the requestor-terminal of the login request.

The relay device selector 56 generates a session ID for identifying sessions for communication of data between terminals. The relay device selector 56 searches the relay device selection management table (illustrated in FIG. 11) based on terminal IDs of requestor-terminals and terminal IDs of counterpart-terminals which are obtained from start-request information transmitted from the requestor-terminals, so as to extract respective relay device IDS. When selecting a relay device 30, the relay device selector 56 selects relay device IDs of relay devices 30 whose operating state are “ON-LINE” among all the relay devices 30 managed on the relay device management table (illustrated in FIG. 6).

The session manager 57 manages distribution-sessions in which content data is transmitted from a terminal to another one or more terminals and call-sessions in which content data is transmitted between multiple terminals. Specifically, the session manager 57 stores and manages, in the session management table (illustrated in FIG. 10) in the non-volatile memory 5000, session IDs generated by a session ID generator 56a, terminal IDs of requestor-terminals, terminal IDs of counterpart-terminals, in association with each other. Further, the session manager 57 stores and manages relay device IDs of selected relay devices 30 in association with respective session IDs. Further, the session manager 57 stores session IDs of distribution-communication identified by conference room IDs in association with the conference room IDs stored in the conference room management table.

The session controller 58 performs session management processing. According to the session management processing, in an event that a connection request from a terminal 10 (i.e. calling) or a connection request to the terminal 10 (i.e. receiving call) is provided while the terminal 10 is connected to a distribution-session, the session controller 58 determines whether to accept the connection request based on information manages in the terminal management DB 5003. In a case of determining to accept the connection request, the session controller 58 forwards the connection request to counterpart-terminals terminal 10 In a case of determining not to accept the connection request, the session controller 58 rejects the connection request and sends the requestor-terminal 10 an error.

In an event of receiving a response to a connection request from a counterpart-terminal 10 or receiving a connection request directing to a counterpart-terminal 10, the session controller 58 determines whether the counterpart-terminal 10 is capable of connecting to multiple sessions at the same time, based on information managed in the terminal management DB 5003. In a case where the counterpart-terminal 10 is not capable of connecting to multiple sessions at the same time and the counterpart-terminal 10 is connected to another session, the session controller 58 may cause the Counterpart-terminal 10 to exit the other session and then forward the connection request to the counterpart-terminal 10. Here, as the counterpart-terminal 10 need not have a function for dealing with a session while connecting to another session, terminals 10 which is not capable of connecting to multiple sessions at the same time may be employed as counterpart-terminals 10.

When connecting (establishing) a call-session to a terminal 10 while a distribution-session is connected to the terminal 10, which is the distributor of the distribution-session, the session controller 58 determines whether sound data is transmitted from the terminal 10 in the distribution-session. In a case where sound data is transmitted, the session controller 58, for example, instructs the terminal 10 to stop transmitting the sound data or instructs the relay device 30 to discard the sound data transmitted from the terminal 10 in the distribution-session so as to stop the transmission of the sound data. In such a case, the session controller 58 informs each of the terminals 10 connected to the distributing that the transmission of sound data is halted, using a message or sound such as “Distribution of sound is currently halted because the distributor is in another session.”

The conference manager 59 stores and manages conference room IDs and terminal IDs in association with each other, in the entrance management table (illustrated in FIG. 12) of the non-volatile memory 5000. Further, the conference manager 59 stores and manages conference room IDs, conference names, and session IDs in association with each other, in the conference room management table (illustrated in FIG. 13) of the non-volatile memory 5000.

The conference manager 59 receives, from a terminal 10 requesting for communication via the transmitter/receiver 51, a entering call start request which is indicative of requesting for starting distribution-communication identified by a conference room ID. The entering call start request includes the terminal ID of the terminal 10 requesting for communication and information for identifying the conference room to be entered (e.g. conference room ID or terminal ID of counterpart-terminals). The conference manager 59 identifies the conference room ID of the conference room to be entered, based on the information for identifying the conference room which is included in the entering call start request, and then determines whether the terminal ID of the requestor-terminal 10 which is included in the entering call start request is associated with the conference room ID. In a case where the terminal ID is associated with the conference room ID, the conference manager 59 requests the session manager 57 to perform session management processing of distribution-communication in accordance with the entering call start request.

The read/write processor 60 (i.e. counterpart-terminal information manager) performs read/write processing from/to the non-volatile memory 5000 and the volatile memory 5100.

<<Processing and Sequence of the First Embodiment>>

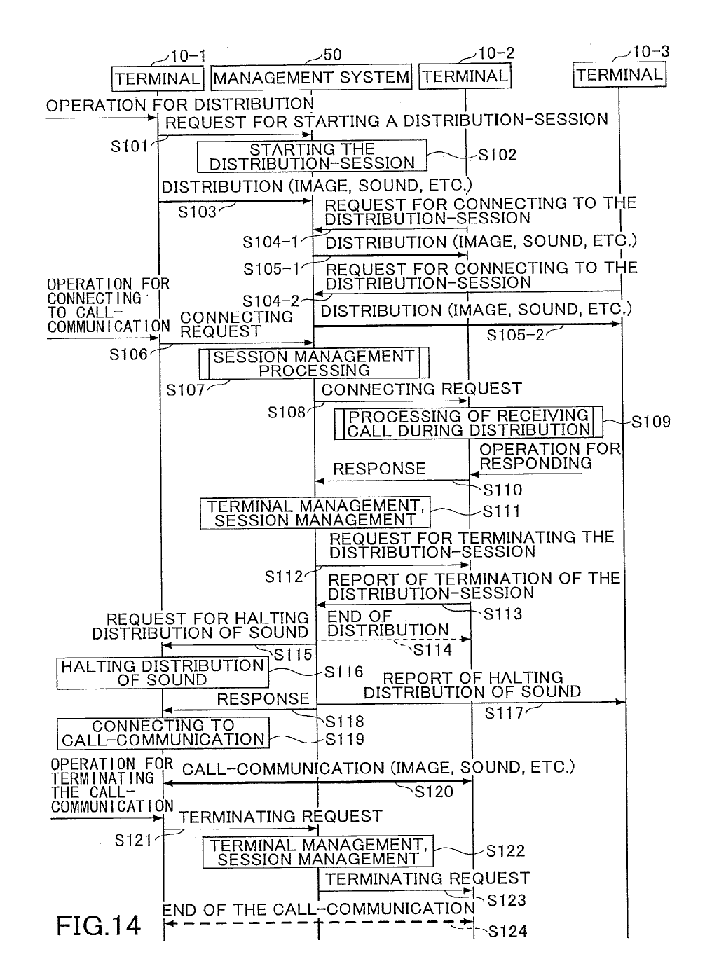

Above are the configuration and functions (or units) of the transmission system 1 according to the first embodiment. In the following, a processing method of the transmission system 1 according to the first embodiment will be described, with reference to FIG. 14 through FIG. 34.

First, the overview of operation of the transmission system 1 in a case of performing communication during distribution in the first embodiment will be described. FIG. 14 is a sequence diagram of the transmission system 1 in a case of performing communication during distribution. In the example of FIG. 14, while at least one of video and sound is distributed from a terminal 10-1 (i.e. first terminal) to a terminal 10-2 (i.e. second terminal), a terminal 10-3 (i.e. third terminal), etc., the terminal 10-1 calls the terminal 10-2 for communication. Here, although the management system 50 and the relay device 30 are considered as one unit in FIG. 14 for the convenience of explanation, transmission of content data such as video and sound is performed by the intermediary of the relay device 30.

The distributor-terminal 10-1 designates a conference room ID and requests the management system to start a distribution-session (step 3101).

The management system 50 starts the distribution-session (step S102).

The distributor-terminal 10-1 enters the conference room and transmits video and sound for distribution (step S103).

The multiple receiver-terminals 10-2, 10-3, etc., designate the conference room ID and connect to the distribution-session which is established in the management system 50 (step S104-1, S104-2). Then, the multiple receiver-terminals 10-2, 10-3, etc., receive the video and sound for distribution transmitted from the distributor-terminal 10-1 (step S105-1, S105-2).

In response to a user operation for connecting to communication with a counterpart-terminal designated by the user, the terminal 10-1 sends a connecting request (i.e. start-request information) directed to the designated counterpart-terminal 10-2 to the management system 50 (step S106). Here, the user may perform an operation for requesting to provide a list of counterpart-terminals before performing the operation for connecting to communication, so that the user can designate the counterpart-terminal from the list of counterpart-terminals provided by the management system 50.

The management system 50 performs session management processing (step S107), and then forwards the connecting request to the counterpart-terminal 10-2 (step S108).

Upon receiving the connecting request, the counterpart-terminal 10-2 performs call-receiving processing (step S100), and then responds to the management system 50 in accordance with a response operation of the user (step 3110).

The management system 50 performs management of terminals and sessions (step S111 of FIG. 14). Specifically, the management system 50 increases the value, in the terminal management DB 5003, of “NUMBER OF SESSION” corresponding to the requestor-terminal 10-1 by 1, switches “OPERATING STATE” corresponding to the counterpart-terminal 10-2 to “ON-LINE (DURING CALL)”, and records a session ID, the terminal ID of the requestor-terminal 10-1, the terminal ID of the counterpart-terminal 10-2, etc.

In a case where, in the terminal management DB 5003, “OPERATING STATE” corresponding to the counterpart-terminal 10-2 is “ON-LINE (DURING DISTRIBUTION)”, the management system 50 requests the counterpart-terminal 10-2 to exit the distribution-session (step S112 of FIG. 14).

The counterpart-terminal 10-2 terminates the distribution-session and reports to the management system 50 that the distribution-session is declined (step S113 of FIG. 14).

The management system 50 causes the counterpart-terminal 10-2 to exit the distribution-session (step S114 of FIG. 14).

In a case where sound data is being transmitted from the requestor-terminal 10-1 in the distribution-session, the management system 50 instructs the requestor-terminal 10-1 to stop transmitting the sound data in the distribution-session (step S115 of FIG. 14).

The requestor-terminal 10-1 stops transmitting the sound data in the distribution-session (step S116 of FIG. 14).

The management system 50 reports that the distribution of sound data is halted to the receiver-terminals 10-3, etc., connected to the distribution-session (step S117 of FIG. 14).

The management system 50 forwards the response from the counterpart-terminal 10-2 to the requestor-terminal 10-1 (step S118 of FIG. 14).

The requestor-terminal 10-1 connects to communication (step S119 of FIG. 14), and then starts one-on-one communication with the terminal 10-2 (step S120 of FIG. 14).

In response to a user operation for declining the communication, the requestor-terminal 10-1 sends a declining request directed to the terminal 10-2 to the management system 50 (step S121 of FIG. 14).

The management system 50 performs management of terminals and sessions (step S122 of FIG. 14). Specifically, the management system 50 decreases the value, in the terminal management DB 5003, of “NUMBER OF SESSION” corresponding to the requestor-terminal 10-1 by 1, switches “OPERATING STATE” corresponding to the counterpart-terminal 10-2 to “ON-LINE (READY FOR CALL)”, and deletes the session ID, the terminal ID of the terminal 10-1, the terminal ID of the terminal 10-2, etc. The management system 50 forwards the declining request to the counterpart-terminal 10-2 (step S123).

The counterpart-terminal. 10-2 terminates the one-on-one communication with the terminal 10-1 (step S124).

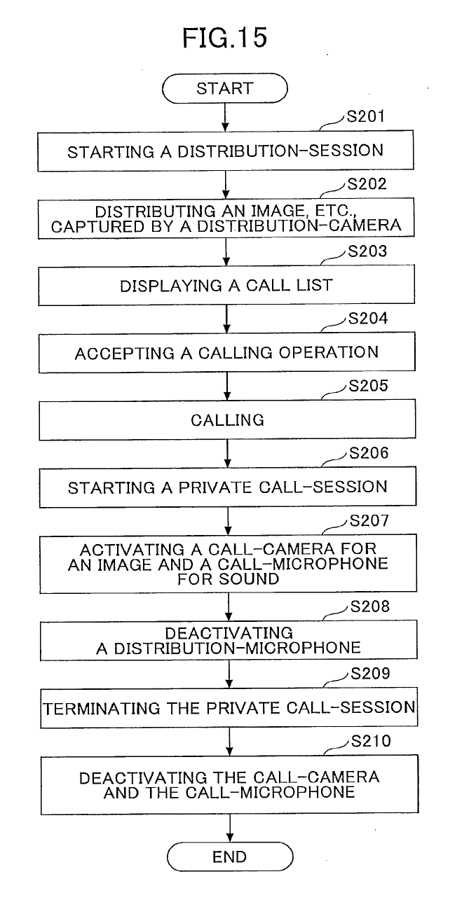

In the following, the operation of the distributor-terminal 10-1 illustrated in FIG. 14 when performing communication during distribution will be described, with reference to FIG. 15. FIG. 15 is a flowchart illustrating processing performed by the distributor-terminal 10-1 when starting communication during distribution.

The requestor-terminal 10-1 starts (establishes) a distribution-session (step 9201), and then displays video captured by the distribution-camera and distributes the video and sound captured by the microphone for distribution (step S202).

Upon receiving an operation for starting communication, a call list is displayed while a distribution is being performed (step S203).

Upon receiving an operation for calling a selected counterpart-terminal (step S204), the requestor-terminal 10-1 calls the counterpart-terminal 10-2 (step S205).

When a communication session with the counterpart-terminal 10-2 is started (step S206), requestor-terminal 10-1 activates (transmits) video captured by the call-camera and sound captured by the microphone for communication (step S207), and deactivate sound captured by the microphone for distribution in order to prevent acoustic feedback (step S208).

Upon terminating the communicating session (step S209), the requestor-terminal 10-1 deactivates the video captured by the call-camera and the sound captured by the microphone for communication, and then returns to the screen for displaying the video captured by the distribution-camera (step S210).

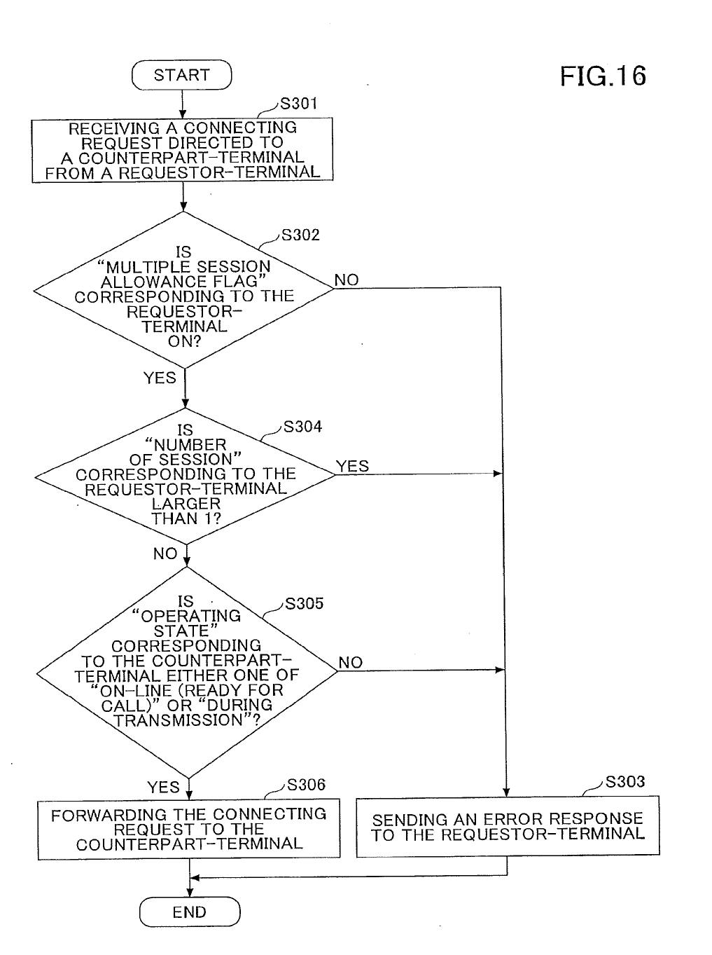

In the following, session management processing performed by the management system 50, which is illustrated in step S107 of FIG. 14, will be described, with reference to FIG. 16. FIG. 16 is a flowchart illustrating the session management processing.

The management system. 50 receives from the requestor-terminal 10-1 a connecting request directed to the counterpart-terminal 10-2 (step S301). The management system 50 determines whether “MULTIPLE SESSION ALLOWANCE FLAG” corresponding to the requestor-terminal 10-1 is ON, with reference to the terminal management DB 5003 (step S302).

In a case where the flag is not ON (NO in step S302), the management system 50 rejects the connecting request and sends an error response to the requestor-terminal 10-1 (step S303).

In a case where the flag is ON (YES in step S302), the management system 50 determines whether “NUMBER OF SESSION” corresponding to the requestor-terminal 10-1 is larger than one, with reference to the terminal management DB 5003 (step S304).

In a case where “NUMBER OF SESSION” is larger than one (YES in step S304), the sequence proceeds to step S303, in which the management system 50 rejects the connecting request and sends an error response to the requestor-terminal 10-1.

In a case where “NUMBER OF SESSION” is not higher than one (NO in step S304), the management system 50 determines whether “OPERATING STATE” corresponding to the counterpart-terminal 10-2 is either one of “ON-LINE (READY FOR CALL)” or “ON-LINE (DURING DISTRIBUTION)” (step S305).

In a case where the “OPERATING STATE” is neither “ON-LINE (READY FOR CALL)” nor “ON-LINE (DURING DISTRIBUTION)” (NO in step S305), the sequence proceeds to step S303, in which the management system 50 rejects the connecting request and sends an error response to the requestor-terminal 10-1.

In a case where the “OPERATING STATE” is either “ON-LINE (READY FOR CALL)” or “ON-LINE (DURING DISTRIBUTION)” (YES in step S305), the management system 50 forwards the connecting request to the counterpart-terminal 10-2 (step S306).

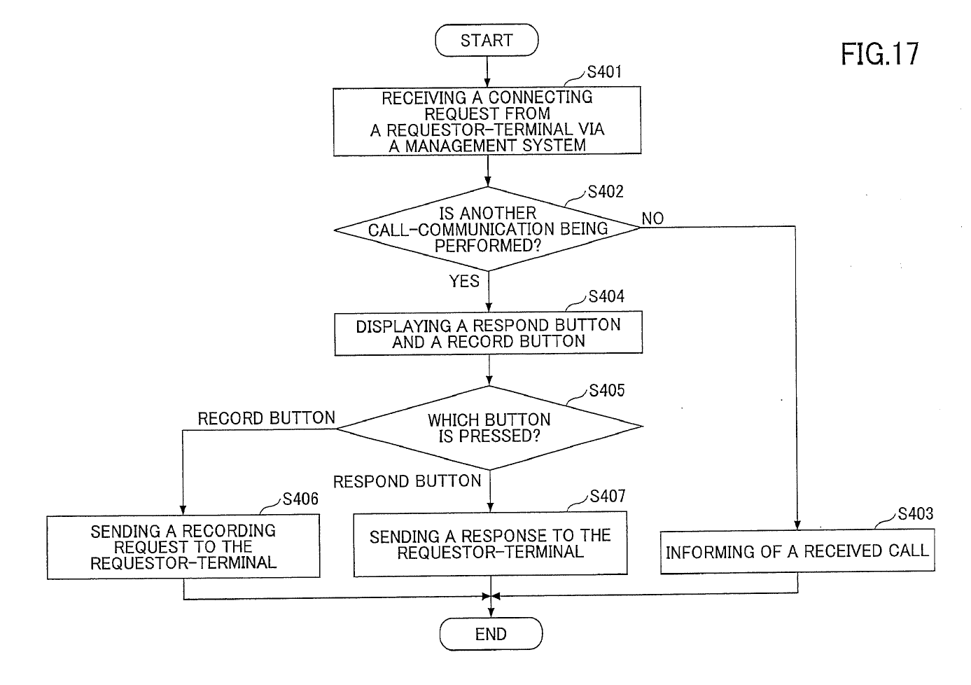

In the following, the operation illustrated in FIG. 14, in which counterpart-terminal 10-2 receives a call for communication while receiving distribution, will be described with reference to FIG. 17. FIG. 17 is a flowchart illustrating call-receiving processing performed by the counterpart-terminal 10-2.

Upon receiving the connecting request from the requestor-terminal 10-1 via the management system 50 (step S401), the counterpart-terminal 10-2 determines whether another communication (i.e. session) is being performed (Step S402).

In a case where another communication is not being performed (NO in step S402) (step S403), the counterpart-terminal 10-2 informs the user of the receiving call. Then, in a case where a response button is pressed, a response (i.e. starting response information) is sent to the requestor-terminal 10-1 through the management system 50.

In a case where another communication is being performed (YES in step S402), the counterpart-terminal 10-2 informs the user of the receiving a call and displays the response button and a record button (step S404). Here, the counterpart-terminal 10-2 may be configured to display a button for rejecting the receiving call.

The counterpart-terminal 10-2 determines which button is pressed (step S405). In a case where the record button is pressed (record button in step S401), the counterpart-terminal 10-2 sends a recording request to the requestor-terminal 10-1 via the management system 50 (step S406).

In a case where the response button is pressed (response button in step S405), the counterpart-terminal 10-2 sends the response (i.e. starting response information) to the requestor-terminal 10-1 via the management system 50 (step S407).

In the following, an example of a screen display of the distributor-terminal 10-1 illustrated in FIG. 14 will be described, with reference to FIG. read/write processor 18. FIG. 18A is a drawing illustrating an example of a screen display where a distribution function is activated. Here, a video-distribution button 501 and a participant-edit button 502 are displayed. FIG. 185 is a drawing illustrating an example of a screen display where the video-distribution button 501 is pressed and distribution is performed as illustrated in S103 of FIG. 14. Here, video captured by camera 112a for distribution is displayed on the display 120 of the distributor-terminal 10-1 itself. Additionally, a call button 503 is displayed.

FIG. 18C is a drawing illustrating an example of a screen display after the call button 503 is pressed. A list of counterpart-terminals is displayed on a higher-level layer of the screen, where a user may select a counterpart-terminal to communicate with. Here, the screen of the list of counterpart-terminals illustrated in FIG. 18C is the same screen illustrated in FIG. 28 which will be described later. FIG. 18D is a drawing illustrating an example of a screen display when having communication in step S120 of FIG. 14. An image 504 from the counterpart-terminal 10-2 and an image 505 captured by the external camera 112b of the distributor-terminal 10-1 are displayed. When the communication ends, the distributor-terminal 10-1 returns to the screen illustrated in FIG. 188.

Next, an example of a screen display of the receiver-terminal 10-2 in FIG. 14 will be described. FIG. 19A is a drawing illustrating an example of a screen display where a distribution function is activated, which displays information regarding conference rooms for distribution (i.e. AA kindergarten and BA kindergarten) available to the receiver-terminal 10-2. FIG. 19B is a drawing illustrating an example of a screen display after entering a conference room for distribution, which displays content data distributed by the distributor-terminal 10-1.

FIG. 19C is a drawing illustrating an example of a screen display when receiving a call for communication from the terminal 10-1 during distribution, which displays a respond button 601 and a record button 602.

FIG. 19D is a drawing illustrating an example of a screen display after the respond button 601 is pressed, which displays an image 603 from the distributor-terminal 10-1 and an image 604 captured by the receiver-terminal 10-2 itself.

FIG. 19E is a drawing illustrating an example of a screen display after the record button 602 is pressed, which displays a massage of performing recording processing. FIG. 19 is a drawing illustrating an example of a screen display after the recording processing is performed, which displays a message that the recording processing is performed.

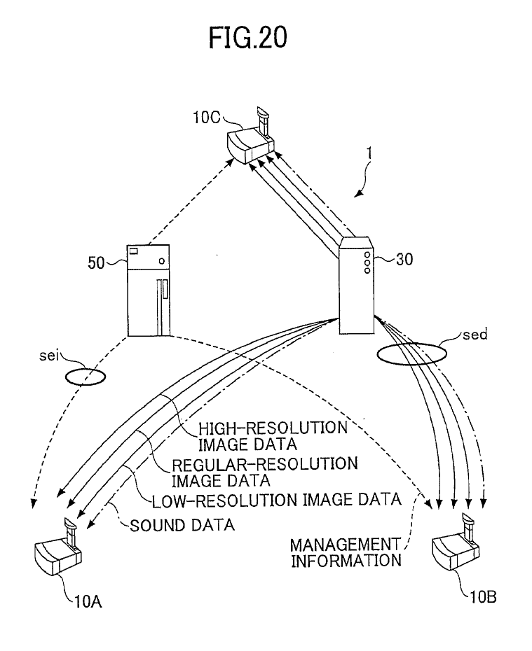

In the following, an overview concept of image data, sound data, and various types of management information in the transmission system 1 will be described, with reference to FIG. 20. FIG. 20 is a conceptual diagram illustrating an arrangement of the image data, the sound data, the various types of management information in the transmission system 1. As illustrated in FIG. 20, a management information transmitting session set is established in the transmission system 1 by the Intermediary of the management system 50 between the terminal 10A, the terminal 10B, and the terminal 10C for the purpose of transmitting and receiving the various types of management information. Further, four sessions are established in the transmission system 1 by the intermediary of the relay device 30 between the terminal 10A, the terminal 10B, and the terminal 10C for the purpose of transmitting and receiving the four respective data of a high-resolution image data, a regular-resolution image data, a low-resolution image data, and a sound data. Here the four sessions are together referred to as an image/sound data transmitting session sed.

Next, a detailed example of processing in FIG. 14 will be described. In the following explanation, the terminals 10-1, 10-2, and 10-3, correspond to terminals 10aa, 10ab, and 10ac, respectively.

First, a detailed example of the distribution function performed with the conference rooms (i.e. distribution rooms) of the transmission system 1 according to the first embodiment. The distribution function is for performing distributing communication where entrance is limited to a requestor-terminal and one or more receiver-terminals. Above all, processing to generate a new conference room for distribution will be described.

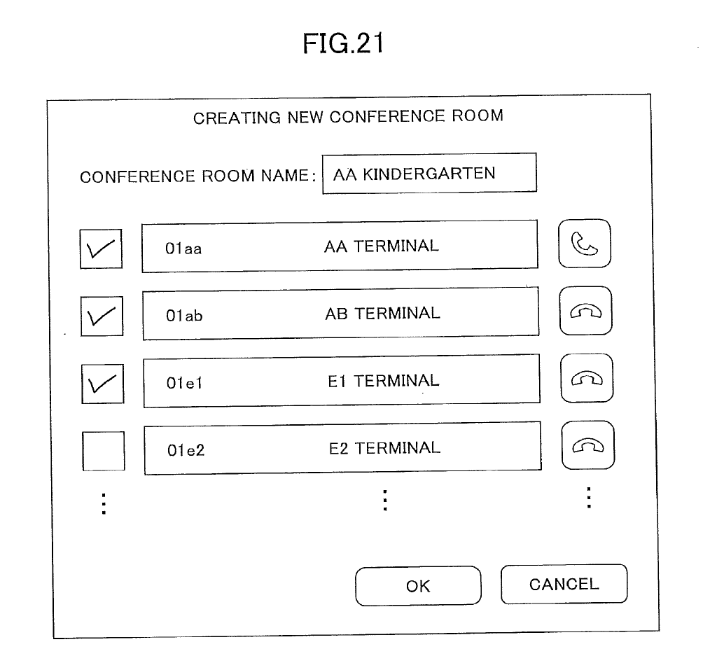

In an event that the operation input acceptor 12 provided in the terminal 10 accepts an operational input of pressing a button for generating a new conference room, the display controller 17 provided in the terminal 10 displays a new conference room creating image on the terminal 10. FIG. 21 is a drawing illustrating an example of the new conference room creating image displayed for creating a new conference room.

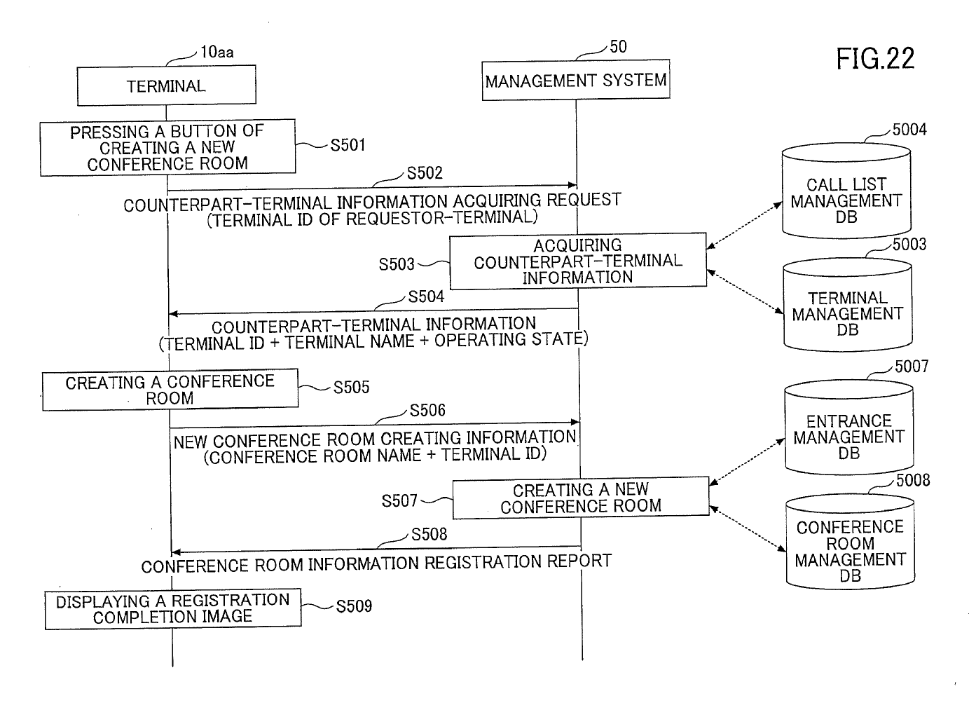

Here, the sequence of processing performed by the terminal 10 and the management system 50 for generating a new conference room, which is performed when a user selects an application for distribution, will be described, taking a user of the terminal 10aa as an example. FIG. 22 is a sequence diagrams illustrating processing of generating a new conference room.

The operation input acceptor 12 of the terminal 10aa accepts an operation input of pressing a button for creating a new conference room from the user (step S501). The transmitter/receiver 11 provided on the terminal 10aa sends a counterpart-terminal information providing request, together with the terminal ID “01aa” of the terminal 10aa, to the management system 50 (step S502).

The terminal extractor 54 provided on the management system 50 receives the counterpart-terminal information providing request through the transmitter/receiver 51. The terminal extractor 54 acquires counterpart-terminal information (i.e. terminal ID, terminal name, and operating state) that corresponds to the terminal 10aa, based on the terminal ID “01aa” of the terminal 10aa received along with the counterpart-terminal information providing request (step S503). Specifically, the terminal extractor 54 first searches the call list management DB 5004 by user of the terminal ID “01aa” of the terminal 10aa received along with the counterpart-terminal information providing request as a search key, and then acquires terminal IDs (e.g. “01ab”, “01e1”, and “01e2”, etc.) of counterpart-terminals. Then, the terminal extractor 54 searches the terminal management DB 5003 by use of the respective terminal IDs (e.g. “01ab”, “01e1”, and “01e2”, etc.) of the counterpart-terminals as search keys, and then acquires terminal names and operating state out of the searched records. For example, in a case where the search key is “01ba”, the terminal extractor 54 acquires a terminal name “BA terminal” and operating state “ON-LINE (READY FOR CALL)” out of the records of the terminal management DB 5003.

Subsequently, the terminal extractor 54 sends counterpart-terminal information, which includes the terminal IDs, the terminal names, and the operating state acquired in step S503, to the terminal 10aa through the transmitter/receiver 51 (step S504). The display controller 17 provided in the terminal 10aa receives the counterpart-terminal information through the transmitter/receiver 11. The display controller 17 displays on the terminal 10aa a new conference room creating screen, which includes the terminal IDs, the terminal names, and operating state of the counterpart-terminals (as illustrated in FIG. 21). The operation input acceptor 12 provided in the terminal 10aa accepts an operation input of selecting a conference name and terminals 10 allowed to enter the conference (step S505). The operation input acceptor 12 provided in the terminal 10aa sends new conference room creating information, which includes the conference name and the terminal IDs of the terminals 10 allowed to enter the conference, to the management system 50 (step 9506).

Next, the conference manager 59 provided in the management system 50 receives the new conference room creating information through the transmitter/receiver 51. The conference manager 59 newly creates a conference room ID that corresponds to the conference name included in the new conference room creating information. The conference manager 59 creates a record associating the conference room ID and the conference room name in the conference room management. DR 5008. Further, the conference manager 59 creates a record associating the conference room ID and the terminal ID, which included in the new conference room creating information, in the entrance management DB 5007 (step S507).

The conference manager 59 sends a conference room information registration report, which indicates that the conference room has been newly created, to the terminal 10aa through the transmitter/receiver 51 (step S508). After, the display controller 17 provided in the terminal 10aa receives the conference room information registration report through the transmitter/receiver 11, the display controller 17 displays a registration completion record, which includes information indicating that the registration of the conference room is completed, on the terminal 10aa (step S509).

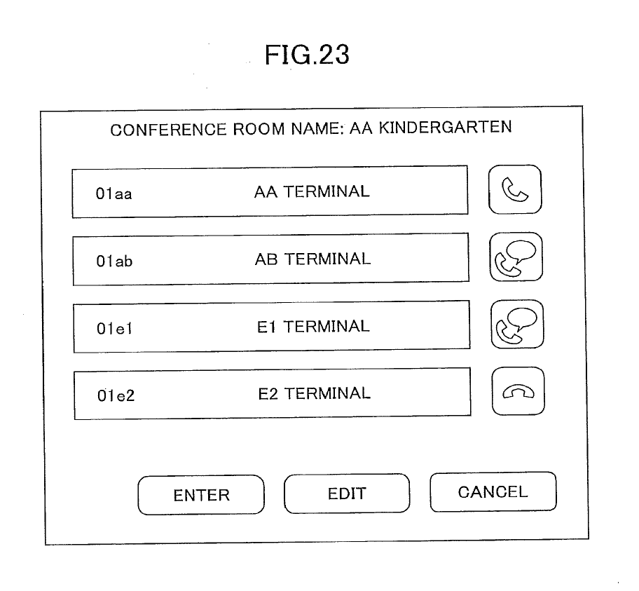

Here, the sequence of processing performed by the terminal 10 and the management system 50 when displaying detailed information of the conference room for distribution and editing the conference room information (i.e. conference room and terminals 10 allowed to enter the conference) will be described. First, a conference room detail screen, which is indicative of detailed information of the conference room, will be described. FIG. 23 is a drawing illustrating an example of the conference room detail screen, which is indicative of detailed information of the conference room. The conference room detail screen illustrated in FIG. 23 includes a conference room name, information (i.e. terminal ID, terminal name, and operating state) of the terminals 10 allowed to enter the conference, an enter button, an edit button, and a cancel button. The conference name is the name of the conference room. The information (i.e. terminal ID, terminal name, and operating state) of the terminals 10 allowed to enter the conference room is information of terminals 10 corresponding to the conference. The enter button is pressed by a user for starting communication in the conference room having the conference name. The edit button is pressed by a user for editing the conference room information (i.e. conference name and terminals 10 allowed to enter the conference) of the conference room having the conference name. The cancel button is pressed by a user for returning to the conference room list screen.

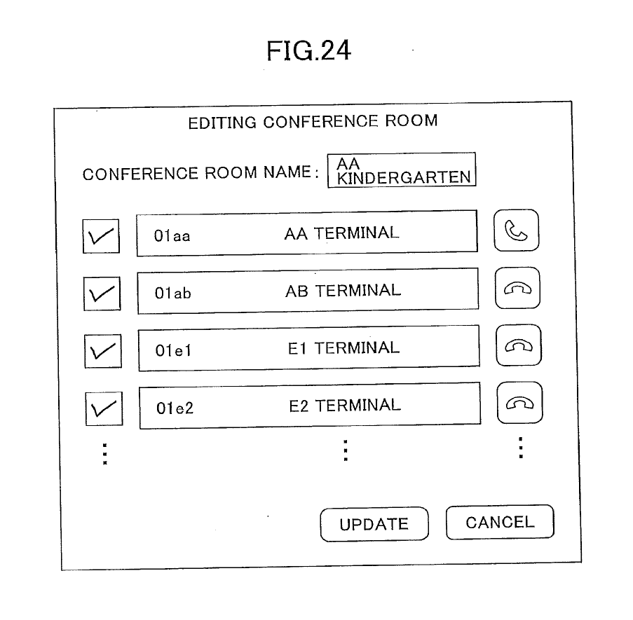

After the operation input acceptor 12 provided in the terminal 10 accepts a press of the edit button, the display controller 17 provided on the terminal. 10 displays a conference room editing screen on the terminal 10. FIG. 24 is a drawing illustrating an example of the conference room editing screen displayed for editing conference room information. The conference room editing screen includes a conference room, information (i.e. terminal IDs, terminal names, and operating state) of terminals 10 allowed to enter the conference, information of currently selected terminals 10 among all of the terminals 10 allowed to enter the conference, an update button, and a cancel button. The conference name is the name of the conference room. The information (i.e. terminal IDs, terminal names, and operating state) of the terminals 10 allowed to enter the conference room is information of receiver-terminals 10 corresponding to the terminal 10 whose conference information is being edited. The information of currently selected terminals 10 among all of the terminals 10 allowed to enter the conference is information of terminals 10 specified by terminal IDs associated with the conference room ID corresponding to the conference. In the example of FIG. 24, terminal information having a check is the information of currently selected terminals 10 among all of the terminals 10 allowed to enter the conference. The update button is pressed by a user for confirming an edited conference room information. The cancel button is pressed by a user for returning to the conference room list screen.

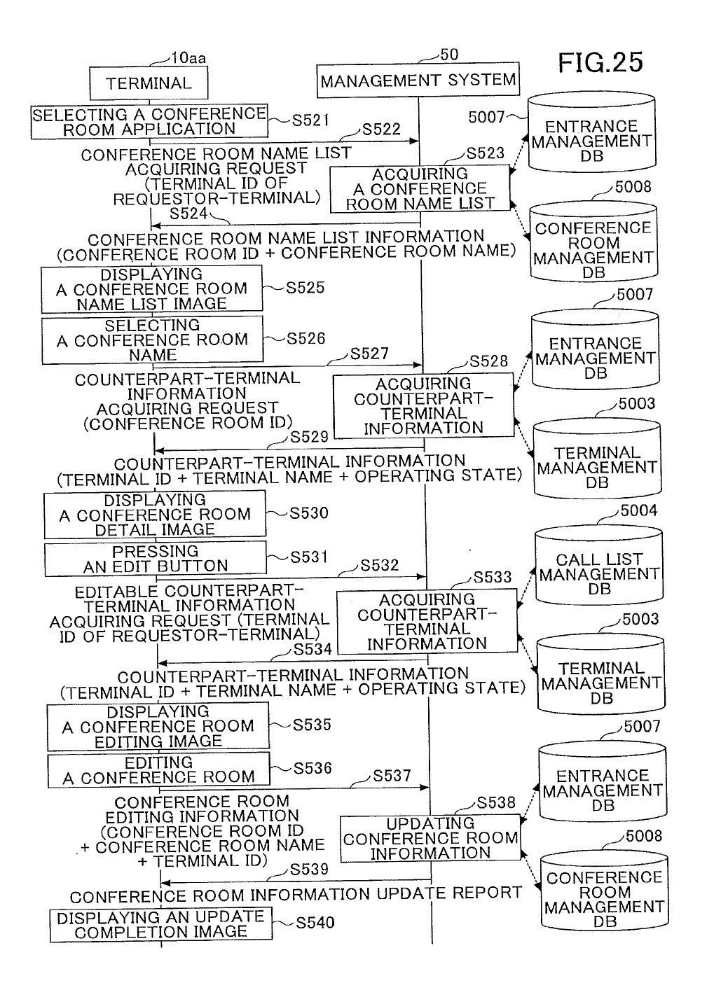

Here, the sequence of processing performed by the terminal 10 and the management system 50 for editing conference room information, which is performed when a user selects an application for distribution, will be described, taking a user of the terminal 10aa as an example. FIG. 25 is a sequence diagrams illustrating processing of displaying a conference room list and editing a conference room.

Steps S521 through S525 are the same as later-described steps S541 through S545, and therefore the explanation will be omitted.

Next, the operation input acceptor 12 provided in the terminal 10aa accepts an operation input of selecting AA kindergarten listed on the conference room list screen from a user (step S526). The transmitter/receiver 11 provided on the terminal 10aa sends to the management system 50 a counterpart-terminal information providing request, along with the conference room ID “1” of AA kindergarten (step S527).

The conference manager 59 provided in the management system 50 receives a counterpart-terminal information providing request through the transmitter/receiver 51. The conference manager 59 acquires the terminal IDs (i.e. “01ab”, “01e1”, and “01e2”) of the counterpart-terminals associated with the conference room ID “1” of AA kindergarten, which is included in the counterpart-terminal information providing request. Then, the terminal extractor 54 searches the terminal management DB 5003 by use of the respective counterpart-terminal IDs (i.e. “01ab”, “01e1”, and “01e2”) as search keys, for acquiring terminal names and operating state out of the searched records. For example, in a case where the search key is “01ab”, the terminal extractor 54 acquires terminal name “AB terminal” and operating state “OFF-LINE” out of the records of the terminal management DB 5003 (step S528).

Subsequently, the terminal extractor 54 sends the counterpart-terminal information acquired in step S228, which includes the terminal IDs, the terminal names, and the operating state, to the terminal 10aa through the transmitter/receiver 51 (step S529). The display controller 17 provided in the terminal 10aa receives the counterpart-terminal information through the transmitter/receiver 11. The display controller 17 displays a conference room detail screen (illustrated in FIG. 23) which includes the terminal IDs, the terminal names, and the operating state of the counterpart-terminal information (step S530). Then, the operation input acceptor 12 provided in the terminal 30aa accepts a pressing of the edit button (step S531). Subsequently, the transmitter/receiver 51 provided in the terminal 10aa sends an editable counterpart-terminal information providing request, along with the terminal ID “01aa” of the terminal 10aa, to the management system 50 (step S532).

The terminal extractor 54 provided in the management system 50 receives the editable counterpart-terminal information providing request through the transmitter/receiver 51. The terminal extractor 54 acquires counterpart-terminal information (i.e. terminal IDs, terminal names, and operating state) of the counterpart-terminals associated with the terminal 10aa, based on the terminal ID “01aa” of the terminal 10aa received along with the editable counterpart-terminal information providing request (step S533). Specifically, the terminal extractor 54 firstly searches the call list management counterpart-terminal DB 5004 by use of the terminal ID “00aa” of the terminal 10aa received along with the editable counterpart-terminal information providing request as a search key, for acquiring counterpart-terminal ID (i.e. “01ab”, “01e1”, and “01e2”) out of the searched records. Then, the terminal extractor 54 searches the terminal management DB 5003 by use of the respective counterpart-terminal IDs (i.e. “01ab”, “01e1”, and “01e2”) as search keys, for acquiring the terminal names and operating state out of the searched records. For example, in a case where the search key is “01ab”, the terminal extractor 54 acquires terminal name “AB terminal” and operating state “OFF-LINE” from the terminal management DB 5003.

Subsequently, the terminal extractor 54 sends the editable counterpart-terminal information (i.e. counterpart-terminal state, information), which includes the terminal IDs, the terminal names, and operating state acquired in step S533, to the terminal 10aa through the transmitter/receiver 51. Upon receiving the editable counterpart-terminal information through the transmitter/receiver 11, the display controller 17 provided in the terminal 10aa displays a conference room editing image (illustrated in FIG. 24) of AA kindergarten including the editable counterpart-terminal information on the terminal 10aa (step S535). In the conference room editing image illustrated in FIG. 24, counterpart-terminal information having a check is counterpart-terminal information of currently selected counterpart-terminals and counterpart-terminal information without a check is counterpart-terminal information of selectable counterpart-terminals.

The operation input acceptor 12 provided in the terminal 10aa receives operation input of editing the conference room information (i.e. conference name and terminals 10 allowed to enter the conference) of AA kindergarten (step S536). After the operation input acceptor 12 provided in the terminal 10aa accepts a pressing of the update button, the transmitter/receiver 11 sends to the management system 50 conference room editing information, which includes information indicative of a conference room ID, a conference name, a terminal ID, or adding or deleting of the terminal ID (step S537).

Next, the conference manager 59 provided in the management system 50 receives the conference room editing information through the transmitter/receiver 51. With regard to the set of the conference room IDs and the terminal IDs included in the conference room editing information, the conference manager 59 adds or deletes records of the entrance management DB 5007 in accordance with the information indicative of adding/deleting of the terminal ID. Further, the conference manager 59 searches the conference room management DB 5008 by use of the conference room IDs included in the conference room editing information, and then updates the conference room names of the searched records to the conference room names obtained from the conference room editing information.

The conference manager 59 sends a conference room information update report, which indicates that an update of the conference room information is completed, to the terminal 10aa through the transmitter/receiver 51 (step S539). Upon receiving the conference room information update report through the transmitter/receiver 11, the display controller 17 provided in the terminal 10aa displays on the terminal 10aa an update completion image, which includes information indicating that the update of the conference room is completed (step S540).

Next, processing performed by the terminal 10 and the management system 50 for starting communication through a conference room will be explained. In the first embodiment, content data is distributed from a terminal 10 which enters a conference room first to each of the terminals 10 which enter the conference room later.

First, a case of selecting a conference name from the conference room list image and the entering a conference room (i.e. starting communication in a conference room of the conference name) will be described.

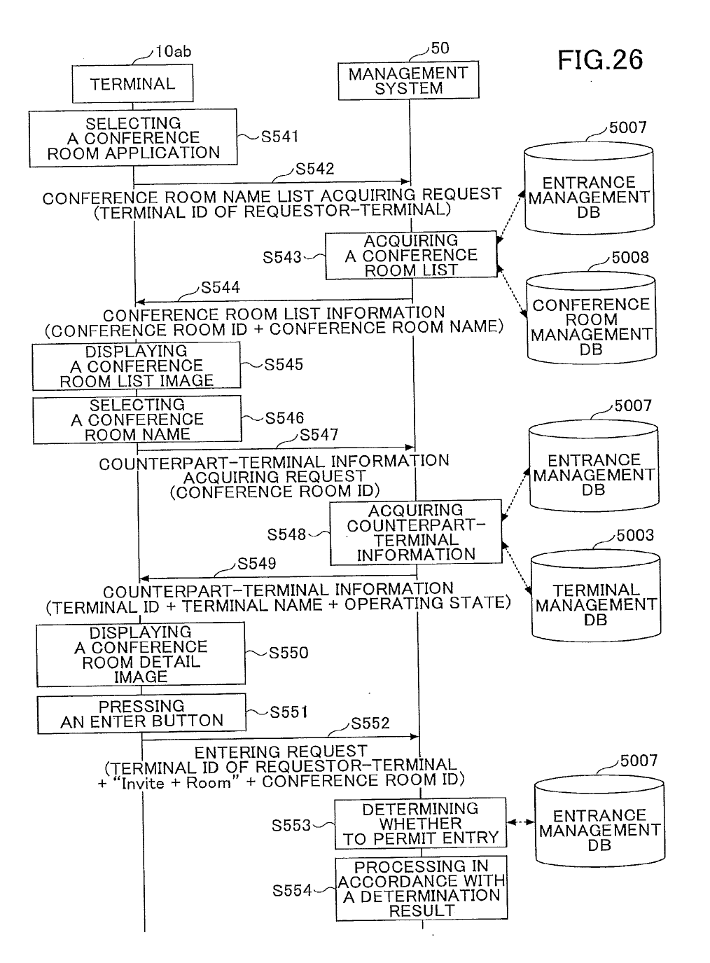

FIG. 26 is a sequence diagram illustrating entering of a conference room for distribution in step S104 of FIG. 14.

The operation input acceptor 12 provided on the terminal 10ab accepts an operation input of selecting an application for distribution (step S541). Then, the transmitter/receiver 11 provided on the terminal 10ab sends the conference name list providing request, along with the terminal ID “01ab” of the terminal 10ab, to the management system 50 (step S542).

Next, the conference manager 59 provided in the management system 50 receives the conference name list providing request through the transmitter/receiver 51. The conference manager 59 acquires a conference room ID and a conference name of a conference room associated with the terminal ID “01ab” of the terminal 10ab, based on the terminal ID “01ab” of the terminal 10ab received along with the conference room list providing request (step S543). Specifically, the conference manager 59 first searches the entrance management DB 5007 by use of the terminal ID “01ab” of the terminal 10ab received along with the conference room list providing request as a search key, for acquiring the conference room IDs (i.e. 1 and 2) out of the searched records. Then the conference manager 59 searched the conference room management DB 5008 for acquiring the conference names (i.e. AA kindergarten and BA kindergarten) of the respective conference room IDs (i.e. 1 and 2).

Then, the conference manager 59 sends the conference room list information, which includes the conference room IDs and the conference room names acquired in step S543, to the terminal 10ab through the transmitter/receiver 51 (Step S544). The display controller 17 provided in the terminal 10ab receives the conference room list information through the transmitter/receiver 11. The display controller 17 provided in the terminal 10ab displays on the terminal 10ab the conference room list image which includes the conference room names obtained from the conference room list information (step S545).

Steps S546 through S550 are the same as steps S526 through S530 of FIG. 25, and therefore the explanation will be omitted.

The operation input acceptor 12 provided in the terminal 10 (i.e. requestor-terminal) accepts operation input of selecting a conference room (step S551). Then, the transmitter/receiver 11 provided on the terminal 10 sends to the management system 50 the terminal ID of the requestor-terminal on which the enter button in pressed, information “Invite+Room” which is indicative of requesting for starting communication for distribution, and a entering request including a conference room ID of the conference room (step S552). The conference manager 59 provided in the management system 50 receives the entering request through the transmitter/receiver 51. The conference manager 59 determines whether, in the entrance management DB 5007, there is a record that matches the set of the conference room ID and the terminal ID included in the entering request (step S553).

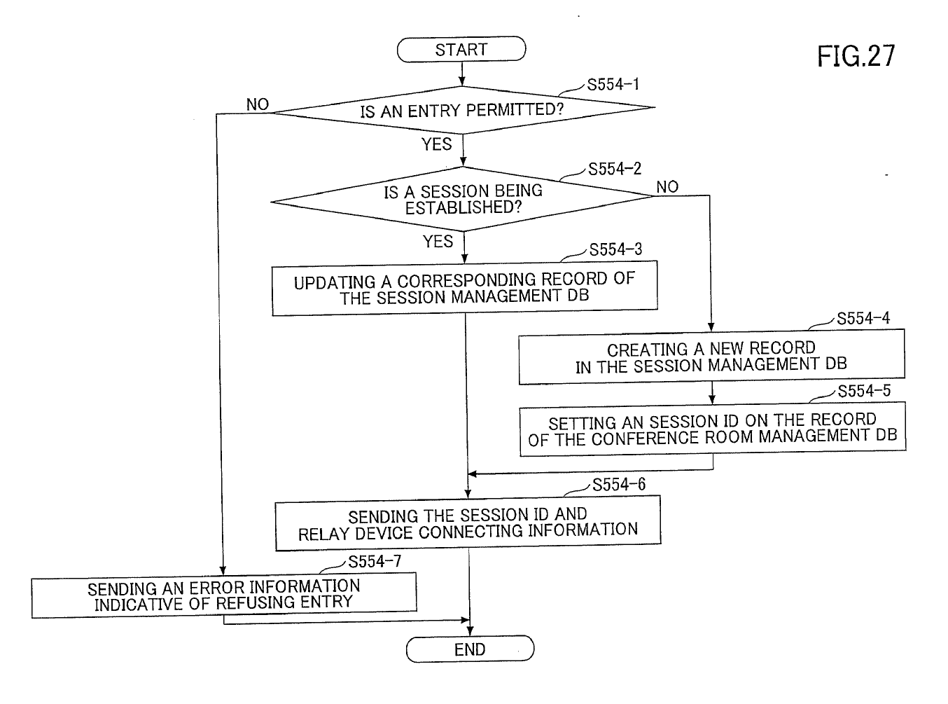

The conference manager 59 performs processing in accordance with an outcome of the determination in step S553. FIG. 27 is a flowchart illustrating the processing in accordance with the outcome of the determination regarding entrance.

In a case where, in the entrance management DB 5007, there is not a record that matches the set of the conference room ID and the terminal ID included in the entering request and the conference manager 59 provided in the management system 50 determines not to admit the entrance (NO in step S554-1), the transmitter/receiver 51 sends an error information, which is indicative of not admitting the entrance, to the requestor-terminal that has sent the entering request (step S554-7).

In a case where, in the entrance management DB 5007, there is a record that matches the set of the conference room ID and the terminal ID included in the entering request and the conference manager 59 provided in the management system 50 determines to admit the entrance (YES in step S554-1), the processing proceeds to step S554-2.

The session manager 57 determines whether communication in a conference room which is specified by the conference room ID included in the entering request is being performed (i.e. whether a session has been established) (step S554-2). Specifically, the session manager 57 searches the conference room management DB 5008 by use of the conference room ID included in the entering request, for determining whether a session ID is set on the “SESSION ID” field of the searched record. That is to say, the session manager 57 determines that a session has been established in case where a session ID is set on the “SESSION ID” field of the searched record.

In a case where a session has been established (YES in step S554-2), the session manager 57 searches the session management DB 5005 by use of the session ID as a search key, and then adds the terminal ID of the requestor-terminal obtained from the entering request to the “COUNTERPART-TERMINAL ID” field of the searched record. The session manager 57 further sets the operating state corresponding to the terminal ID obtained from the entering request to “ON-LINE (DURING DISTRIBUTION)” (step S554-3), and then the processing proceeds to step S554-6.

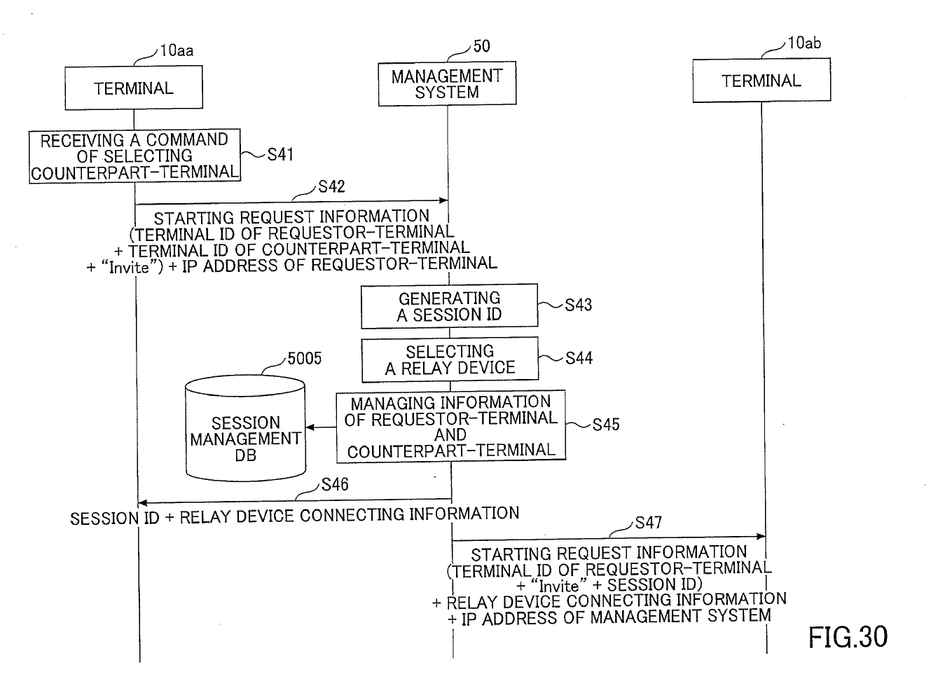

In a case where a session has not been established (NO in step S554-2), the session manager 57 generates a new session ID, and then generates a new record in the session management DB 5005 (step S554-4). Here, specific processing of generating a session ID is the same as the processing through step S43 to S45 of FIG. 30, except that the same value as a value in the “REQUESTOR-TERMINAL ID” field is set on the “COUNTERPART-TERMINAL ID” field in step S45.

Subsequently, the conference manager 59 searches the conference room management DB 5008 by use of the conference room ID obtained from the entering request as a search key, and then sets the session ID newly generated in step S544-4 on the “SESSION ID” field of the searched record (step S554-5).

Subsequently, the transmitter/receiver 51 sends the session ID and a relay device connecting information (i.e. IP address, authentication information, port number, etc., of the relay device 30) to the requestor-terminal which the entering request is sent from. Above is the processing of connecting the requestor-terminal and the relay device 30. After the processing, processing of requesting for relaying communication data in which the requestor-terminal sends a relay requesting information to the management system 50 (as illustrated in step S61-1 through S65-1 of FIG. 23). In such a way, the requestor-terminal, which has sent the participating information when detecting that the conference name on the conference room list is selected by the user, starts communication for distribution in the conference room.

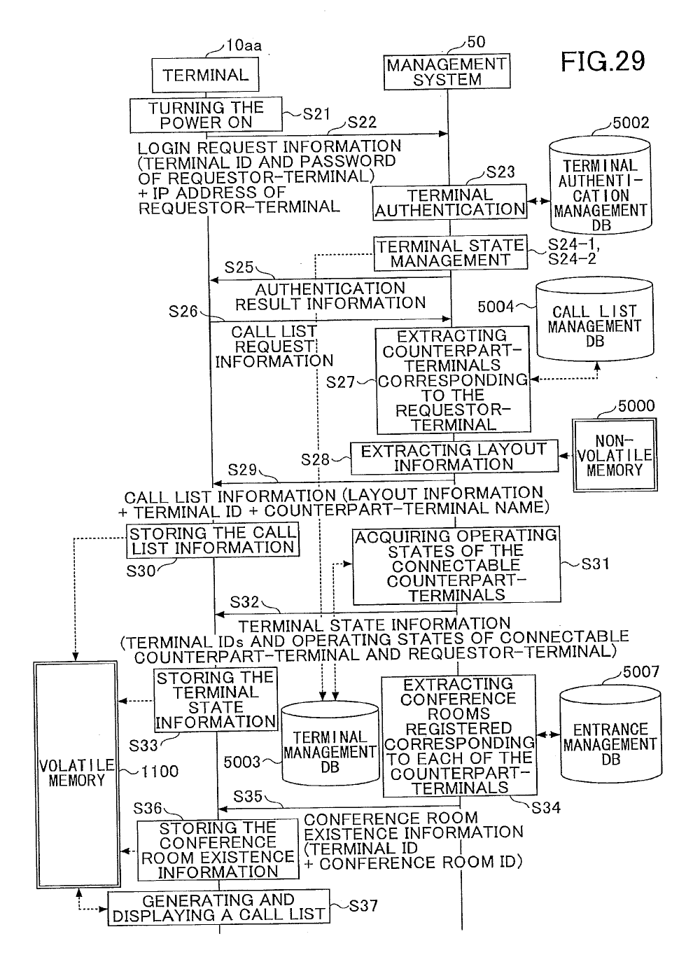

Next, processing of displaying an image including the counterpart-terminal state listing information on the terminal 10aa will be explained, with reference to FIG. 28 and FIG. 29. Here, the processing of acquiring the call list as illustrated in FIG. 18C from the management system 50 is the same as the processing, as described above, of acquiring a call list from the management system 50 at the time of starting up the terminal 10.

FIG. 28 is a drawing illustrating an example of the image including the counterpart-terminal state listing information. The counterpart-terminal state listing image indicates the counterpart-terminal state listing information which includes one or more sets of counterpart-terminal state information, such as information indicative of a counterpart-terminal associated with the requestor-terminal of the communication and information (i.e. image 1500) indicative as to whether there is a conference room associated with a terminal. Counterpart-terminal information having the image 1500 indicates that communication for distribution (i.e. virtual conference room), in which the counterpart-terminal is allowed to enter, is registered in the management system 50. Further, in the example of the counterpart-terminal state listing image of FIG. 28, there are operating state information (i.e. image 1501, image 1502, image 1503, and image 1504) indicative of operating state of the counterpart-terminals. The image 1501 indicates that the counterpart-terminal is “ON-LINE (READY FOR CALL)”. The image 1502 indicates that the counterpart-terminal is “ON-LINE (DURING CALL)”. The image 1503 indicates that the counterpart-terminal is “OFF-LINE”. The image 1504 indicates that the counterpart-terminal is “ON-LINE (DURING DISTRIBUTION)”.

In the example of FIG. 28, a counterpart-terminal button 1505 of terminals whose operating state is “ON-LINE (DURING CALL)” or “OFF-LINE” (i.e. “01e1” and “01e2”) may be grayed out, so as not able to be pressed. In such a way, a user may check on the screen of the call list whether a counterpart-terminal can receive a call. On the other hand, in events that the respective counterpart-terminal buttons 1505 are pressed, the terminals whose operating state is “ON-LINE (READY FOR CALL)” or “ON-LINE (DURING DISTRIBUTION)” (i.e. “01ab” and “01e3”) can receive calls. FIG. 29 is a sequence diagram illustrating processing of displaying the image including the counterpart-terminal state listing information on the terminal. Here, in FIG. 29, communication between the terminal 10 and the management system 50 is performed through the management information transmitting session sei.

First, when a user of the terminal 10aa turns on the power switch 109 illustrated in FIG. 3, the operation input acceptor 12 illustrated in FIG. 5 accepts the operation and turns on the power (step S21). Then, upon accepting the operation of turning on the power, the login requester 13 automatically transmits login-request information that is indicative of a request for login through the transmitter/receiver 11 to the management system 50 via the communication network 2 (step S22). The login-request information includes the terminal ID for specifying the requestor-terminal 10aa itself and a password. The data of the terminal ID and the password is retrieved by the read/write processor 18 from the non-volatile memory 1000 and transmitted through the transmitter/receiver 11. Here, the management system 50, which is the receiver of the login-request information, can obtain the IP address of the terminal 10aa, which is the sender of the login-request information, at the time that the login-request information is transmitted from the terminal 10aa to the management system 50.

Then, the terminal authenticator 52 provided in the management system 50 searches the terminal authentication management table (illustrated in FIG. 7) in the non-volatile memory 5000 by use of the terminal ID and the password obtained from the login-request information received through the transmitter/receiver 51 as search keys, and then determines whether there is a record that matches the terminal ID and the password in the terminal authentication management DB 5002, for the purpose of terminal authentication (step S23).

In a case where there is a record that matches the terminal ID and the password in the terminal authentication management DB 5002, the state manager 53 searches the terminal management table (illustrated in FIG. 8) by use of the terminal ID as a search key, and then sets, on the “DATE/TIME OF RECEPTION” field of the searched record, the date and time of receiving the login-request information. Further, the state manager 53 stores, on the “IP ADDRESS” field of the searched record, the IP address which is included in the login-request information (step S24-1). In such a way, on the terminal management table illustrated in FIG. 8, date/time of reception “2009.11.10 13:40” and terminal IP address “1.2.1.3” are stored in association with terminal ID “01aa”.

Then, the state manager 53 sets the operating state of the terminal 10aa to “ON-LINE (READY FOR CALL)” on the “OPERATING STATE” field of the searched record (step S24-2). In such a way, the terminal management table illustrated in FIG. 8 manages the operating state “ON-LINE (READY FOR CALL)” in association with the terminal ID “01aa”.

Then, the transmitter/receiver 51 provided in the management system 50 sends authentication result information which is indicative of the authentication result produced by the terminal authenticator 52 to the requestor-terminal (i.e. terminal 10aa) from which the login-request is sent (step S25). The following description of the first embodiment explains a case where the terminal authenticator 52 determines to authenticate the terminal.

Upon receiving the authentication result information indicating that the terminal is authenticated, the terminal 10aa sends call list requesting information indicative of requesting for a call list to the management system 50 through the transmitter/receiver 11 via the communication network 2 (step S26). Then, the transmitter/receiver 51 provided in the management system 50 receives the counterpart list requesting information.

Then, the terminal extractor 54 searches the call list management table (illustrated in FIG. 9) by use of the terminal ID “01aa” of the requestor-terminal (i.e. terminal 10aa) of the login request as a search key, and then retrieves/extracts the terminal IDs of connectable counterpart-terminals capable of communicating with the requestor-terminal (i.e. terminal 10aa) (step S27). Further, the terminal extractor 54 searches the terminal management table (illustrated in FIG. 8) by use of the extracted terminal IDs as search keys, and then retrieves/extracts the counterpart-terminal names that correspond to the terminal IDs. Here, the terminal extractor 54 extracts terminal IDs (“01ab”, “01e1”, “01e2”, etc.) of the respective counterpart-terminals (10ab, 10e1, 10e2, etc.) which correspond to the terminal ID “01aa” of the requestor-terminal (terminal 10aa).

Then, the read/write processor 60 of the management system 50 retrieves from the non-volatile memory 5000 layout information indicative of a display format of the counterpart-terminal listing image (step S28), and sends to the requestor-terminal (terminal 10aa) “call list information (i.e. layout information, terminal IDs, and counterpart-terminal names)” which includes the layout information and the terminal IDs and the counterpart-terminal names which are extracted by the terminal extractor 54 (step S29). Then, the call list information is received by the transmitter/receiver 11 and stored in the volatile memory 1100 by the read/write processor 18 (step S30).

Further, the terminal state acquirer 55 provided in the management system 50 searches the terminal management table (illustrated in 8) by use of the terminal IDs (“01ab”, “01e1”, “01e2”, etc.) of the connectable counterpart-terminals extracted by the terminal extractor 54 as search keys, and retrieves/acquires the operating state of the connectable counterpart-terminals (10ab, 10e1, 10e2, etc.) which correspond to the respective terminal IDs extracted by the terminal extractor 54 (step S31).

Then, the transmitter/receiver 51 sends to the requestor-terminal (terminal 10aa) via the communication network 2 “terminal state information” which includes information of “MULTIPLE SESSION ALLOWANCE FLAG” corresponding, in the terminal management table (illustrated in FIG. 8), to the requestor-terminal (terminal 10aa) of the login request, the terminal IDs (“01ab”, “01e1”, “01e2”, etc.) used as the search keys in step S31, and the operating state of the counterpart-terminals (10ab, 10e1, 10e2, etc.) corresponding to the terminal IDs (step S32).

The, the read/write processor 18 provided in the requestor-terminal (terminal 10aa) store in the volatile memory 1100 the terminal state information received from the management system 50 (step S33). In such a way, the requestor-terminal (terminal 10aa) may acquire current operating state of connectable counterpart-terminals 10 capable of communicating with the requestor-terminal (terminal 10aa).

Further, the conference manager 59 provided in the management system 50 searches the entrance management table (illustrated in FIG. 12) by use of the terminal IDs (“01ab”, “01e1”, “01e2”, etc.) of the connectable counterpart-terminals extracted by the terminal extractor 54 as search keys, and retrieves conference room IDs associated with the respective terminal IDs extracted by the terminal extractor 54, if any (step S34).

Then, the conference manager 59 provided in the management system 50 sends to the terminal 10aa through the transmitter/receiver 51 conference room existing information, which includes the terminal IDs and the conference room IDs corresponding to the respective terminal IDs (step S35). Then, the read/write processor 18 provided in the requestor-terminal (terminal 10aa) stores the conference room existing information received from the management system 50 through the transmitter/receiver 11 in the volatile memory 1100 (step S36). Then, the call list generator 20 provided in the terminal 10aa generates a call list (i.e. counterpart-terminal state listing information), based on the “MULTIPLE SESSION ALLOWANCE FLAG” information, the call list information, the state information, the conference room existing information. Then, the display controller 17 provided in the requestor-terminal (terminal 10aa) the call list on the display 120 illustrated in FIG. 3, as the counterpart-terminal state listing image (illustrated in FIG. 28) (step S37).

According to the processing described above, the image including the counterpart-terminal state listing information illustrated in FIG. 28 is displayed on the display 120aa provided on the terminal 10aa by the intermediary of the management system 50. In the counterpart-terminal state listing image according to the first embodiment, the information indicating whether there are conference rooms associated with respective counterpart-terminals is expressed by existence of an conference room icon (i.e. image 1504) assigned to each of the counterpart-terminal state information.

Next, processing of requesting for starting a call-session during distribution, as illustrated in step S106 of FIG. 14, will be explained, with reference to FIG. 30. Here, in FIG. 30, the entire communication between the terminal 10 and the management system 50 is performed through the management information transmitting session sei. Further, in the first embodiment, the requestor-terminal (terminal 10aa) is capable of starting communication with one or more terminals, among the connectable counterpart-terminals listed on the counterpart-terminal listing image (illustrated in FIG. 28), whose operating state are “ON-LINE (READY FOR CALL)” or “ON-LINE (DURING DISTRIBUTION)”.

First, when a user of the requestor-terminal (i.e. terminal 10aa) presses the operation button 108 illustrated in FIG. 3 for selecting the counterpart-terminal (i.e. terminal 10ab), the operation input acceptor 12 illustrated in FIG. 5 accepts a request for starting call-communication with terminal 10ab (step S41). Then, the transmitter/receiver 11 provided in the terminal 10aa sends to the management system 50 start-request information, which includes the terminal ID “01aa” of the requestor-terminal (i.e. terminal 10aa), the terminal ID “01ab” of the counterpart-terminal (terminal 10ab), and information “Invite” which is indicative of requesting for starting conversation through call-communication (step S42). In such a way, the transmitter/receiver 51 provided in the management system 50 receives the start-request information and obtains the IP address “1.2.1.3” of the requestor-terminal (i.e. terminal 10aa) which is the sender of the request.

Then the session ID generator 56a generates a session ID “se2” for specifying the communication (i.e. image/sound data transmitting session sed) performed between the requestor-terminal (i.e. terminal 10aa) and each of the counterpart-terminals (step S43). After the session ID is generated, the session manager 57 stores the session ID “se2” and the number of the counterpart-terminals “2” in the volatile memory 5100. The number of the counterpart-terminals is utilized for determining, when change-request information “Reject” which is indicative of rejecting start of the communication is received later, whether the change-request information “Reject” is received from all of the counterpart-terminals.

Then, the relay device selector 56 provided in the management system 50 selects a relay device 30 which relays communication between the requestor-terminal (i.e. terminal 10aa) and the counterpart-terminal (i.e. terminal 10ab), based on the relay device management DB 5001 and the relay device selection management DB 5006 (step S44). Here, the relay device extractor 56b searches the relay device selection management table (illustrated in FIG. 11) by use of the terminal ID “01aa” of the requestor-terminal (i.e. terminal 10aa) and the terminal ID “01ab” of the counterpart-terminal (i.e. terminal 10ab) which are included in the start-request information sent from the requestor-terminal (i.e. terminal 10aa), and then extracts the relay device IDs (i.e. “111a” and “111a”) which correspond to the terminals 10aa and 10ab.

In a case where all of the extracted relay device IDs are the same, the selector 56c refers to the operating state of the extracted relay device ID, among the operating states of the relay devices 30 managed in the relay device management table (illustrated in FIG. 6). Here, in a case where the operating state corresponding to the relay device ID is “ON-LINE”, the selector 56c selects the extracted relay device as a relay device for relaying the communication. In a case where all of the extracted relay device IDs are not the same or in a case where the operating state corresponding to the extracted relay device ID is “OFF-LINE” as a result of the above referencing, the selector 56c selects the relay device 30e having relay device ID “ille” as a relay device for relaying the communication. In the description of the first embodiment, a case of selecting the relay device 30e will be explained.

After performing the processing of selecting the relay device 30, the session manager 57 stores and manages the terminal ID “01aa” of the requestor-terminal (i.e. terminal 10aa), the terminal ID “01ab” of the counterpart-terminal (i.e. terminal 10ab), and the relay device ID “111e” of the selected relay device 30e in each of the fields “REQUESTOR-TERMINAL ID”, “COUNTERPART-TERMINAL ID”, and “RELAY DEVICE ID” of the record associated with the session ID “se2” in the session management table (illustrated in FIG. 10) of the non-volatile memory 5000 (step S45).

Then, the transmitter/receiver 51 illustrated in FIG. 5 sends to the requestor-terminal (i.e. terminal 10aa) via the communication network 2 the session ID generated by the session ID generator 56a and the relay device connecting information utilized for connecting to the relay device 30e selected by the selector 56c (step S46). The relay device connecting information may include the IP address “1.1.1.3”, the authentication information, the port number, etc., of the relay device 30e. In such a way, the terminal 10aa may obtain the relay device connecting information used for connecting to the relay device 30e which relays the communication data, when the session of the session ID “se2” is performed.

Then, the transmitter/receiver 51 sends to the counterpart-terminal (i.e. terminal 10ab) the terminal ID “01aa” of the requestor-terminal (i.e. terminal 10aa), the change-request information “Invite” which is indicative of requiring for starting communication with the counterpart-terminal, the start-request information including the session ID “se2”, the relay device connecting information used for connecting to the relay device 30e, and the IP address of the management system 50 (step S47). In such a way, the transmitter/receiver 51 provided in the counterpart-terminal (i.e. terminal 10ab) receives the start-request information and obtains the relay device connecting information used for connecting to the relay device 30e which relay the communication data and the IP address of the management system 50 from which the communication data is sent.

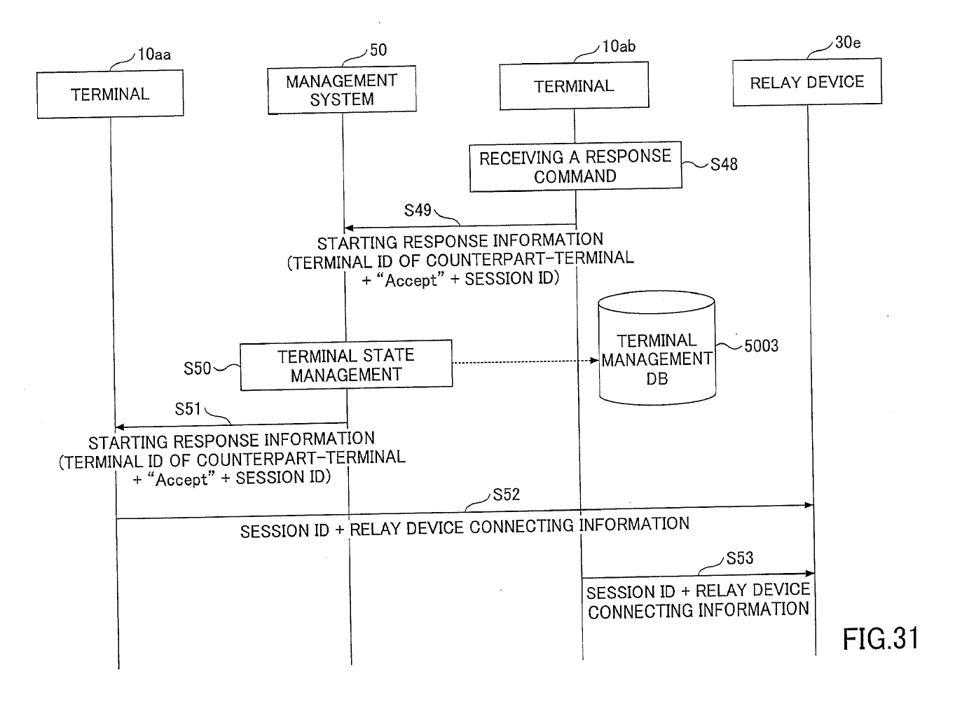

Next, the following description explains processing performed when the counterpart-terminal (i.e. terminal 10ab) receives the start-request information and then the user of the counterpart-terminal presses the operation button 108 illustrated in FIG. 3 so that a response that allows the request for starting the communication with the requestor-terminal (i.e. terminal 10aa) is accepted. FIG. 31 is a sequence diagram illustrating the processing of allowing the request for starting the communication. The response of allowing the start of the communication with the requestor-terminal (i.e. terminal 10aa) is accepted through the operation button 108 of the counterpart-terminal (i.e. terminal 10ab) (step S48). Then, the transmitter/receiver 11 of the counterpart-terminal (i.e. terminal 10ab) sends to the management system 50 the terminal ID “01ab” of the counterpart-terminal (i.e. terminal 10ab), the terminal ID “01aa” of the requestor-terminal (i.e. terminal 10aa), information “Accept” which is indicative of allowing the start of the communication, and the session ID “se2” (step S49).

After the transmitter/receiver 51 of the management system 50 receives such starting response information, the state manager 53 searches the terminal management table (illustrated in FIG. 8) by use of the terminal ID “01aa” of the requestor-terminal (i.e. terminal 10aa) and the terminal ID “01ab” of the counterpart-terminal (i.e. terminal 10ab), and then updates the “OPERATING STATE” fields of the respective records having the terminal ID “01aa” and the terminal ID “01ab” to “ON-LINE (DURING CALL)” (step S50).

Then, the transmitter/receiver 51 sends to the requestor-terminal (i.e. terminal 10aa) the starting response information which includes the terminal ID “01ab” of the counterpart-terminal (i.e. terminal 10ab), the change-request information “Accept” which is indicative of allowing the request for starting the communication with the counterpart-terminal, and the session ID “se2” (step S51). Upon receiving the starting response information, the requestor-terminal (i.e. terminal 10aa) sends to the relay device 30e through the transmitter/receiver 11 the session ID “se2” and the relay device connecting information acquired in step S46, so as to connect to the relay device 30e (step S52). Meanwhile, the counterpart-terminal (i.e. terminal 10ab) sends to the relay device 30e through the transmitter/receiver 11 the session ID “se2” and the relay device connecting information acquired in step S47-2, so as to connect to the relay device 30e (step S53).

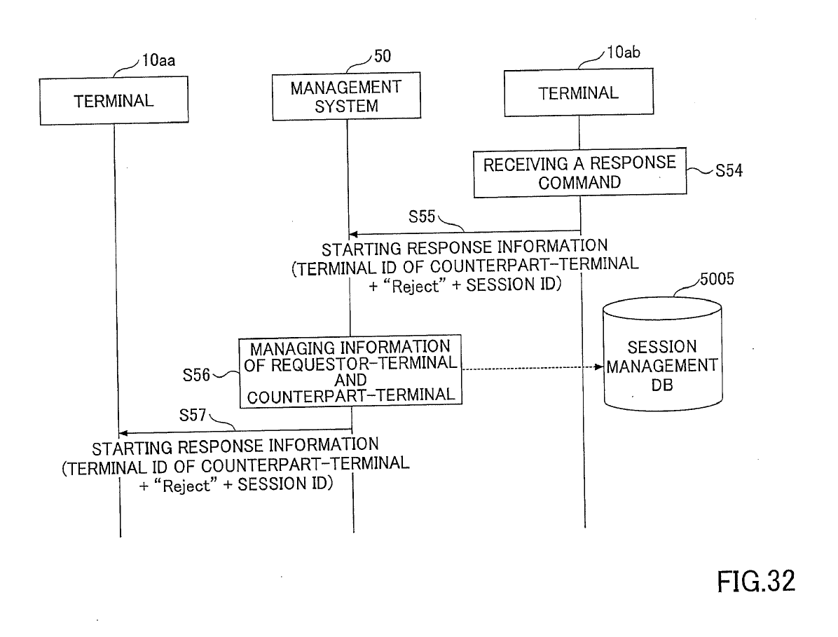

The following description explains processing performed when a user of the counterpart-terminal (i.e. terminal 10ab) which has received the starting request information in step S47 presses the operation button 108 illustrated in FIG. 3, so that the request for starting a communication with the requestor-terminal (i.e. terminal 10aa) is rejected. FIG. 32 is a sequence diagram illustrating the processing of rejecting the request for starting the communication. Upon receiving a response command of rejecting the start of the communication with the requestor-terminal (i.e. terminal 10aa) through the operation button 108 provided on the counterpart-terminal (i.e. terminal 10ab) (step S54), the transmitter/receiver 11 provided in the counterpart-terminal (i.e. terminal 10ab) sends to the management system 50 starting response information which includes the terminal ID “01ab” of the counterpart-terminal (i.e. terminal 10ab), changing request information “Reject” which is indicative of rejecting the request for starting the communication, and the session ID “se2” (step S55).

Then the session manager 57 deletes the terminal ID “01ab” of the counterpart-terminal (i.e. terminal 10ab) from the “counterpart-terminal” field of the record having the session ID “se2”, in the session management table (illustrated in FIG. 10) of the non-volatile memory 5000 (step S56). Further, the transmitter/receiver 51 sends the requestor-terminal (i.e. terminal 10aa) the starting response information, which includes the terminal ID “01ab” of the counterpart-terminal (i.e. terminal 10ab), response information “Reject” which is indicative of rejecting the request for starting the communication, and the session ID “se2” (step S57). In such a way, the requestor-terminal (i.e. terminal 10aa) is informed that the request for starting the communication with the counterpart-terminal (i.e. terminal 10ab) is rejected.

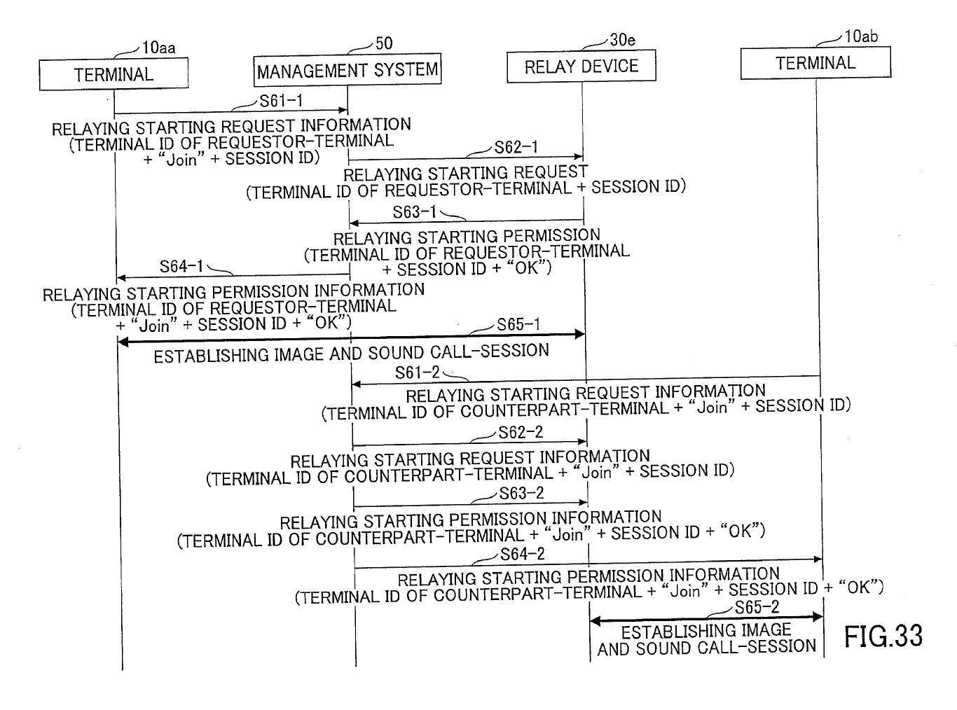

The next description explains processing performed when the a session for transmitting call data is established as illustrated in FIG. 33 and the relay device 30e starts relaying the call data transmitted between the requestor-terminal (i.e. terminal 10aa) and the counterpart-terminal (i.e. terminal 10ab). Here, the communication for establishing the session for transmitting images and sound is performed through the management information transmitting session sei.

First, after the requestor-terminal (i.e. terminal 10aa) connects to the relay device 30e (as illustrated in step S52), the requestor-terminal (i.e. terminal 10aa) sends to the management system 50 through the transmitter/receiver 11 relaying request information, which includes the terminal ID “01aa” of the requestor-terminal (i.e. terminal 10aa), the session ID “se2”, and information “Join” which is indicative of requesting for starting relaying (step S61-1).

Upon receiving the relaying starting request information, the transmitter/receiver 51 provided in the management system 50 performs connecting control for establishing the communication. First, the management system 50 sends to the relay device 30e a relaying starting request, which includes the terminal ID “01aa” of the terminal requestor-terminal (i.e. terminal 10aa) and the session ID “se2” (step S62-1). Upon receiving the relaying starting request, the relay device 30e sends to the management system 50 relaying starting permission information, which includes reporting information “OK” indicative of permitting the start of the relaying (step S63-1). Upon receiving the response, the transmitter/receiver 51 provided in the management system 50 sends to the requestor-terminal (i.e. terminal 10aa) the relaying starting permission information (step S64-1). In such a way, the image/sound data transmitting session sed is established between the requestor-terminal (i.e. terminal 10aa) and the relay device 30a (step S65-1).

On the other hand, after the counterpart-terminal (i.e. terminal 10ab) connects to the relay device 30e (in step S53), the transmitter/receiver 11 provided in the counterpart-terminal (i.e. terminal 10ab) sends to the management system 50, at a predetermined timing, relaying starting request information which includes the terminal ID “01ab” of the counterpart-terminal (i.e. terminal 10ab), the session ID “se2”, and information “Join” indicative of requesting for starting relaying (step S61-2).

Then, the management system 50 and the relay device 30e perform the same processing as in steps S62-1, S63-1, and S64-1, so that an image/sound data transmitting session sed is established between the counterpart-terminal (i.e. terminal 10ab) and the relay device 30e (steps S62-2, S63-2, S64-2, and S65-2). After the image/sound data transmitting session sed is established between the counterpart-terminal (i.e. terminal 10ab) and the relay device 30e, the relay device 30a may relay three types of image data (i.e. high-resolution image data, regular-resolution image data, and low-resolution image data) and sound data, which enables the terminals 10aa and 10ab to perform a teleconference.

Next, the following description explains processing performed when, after the image/sound data transmitting session is established between the requestor-terminal (i.e. terminal 10aa) and the counterpart-terminal (i.e. terminal 10ab), the requestor-terminal (i.e. terminal 10aa) leaves (i.e. terminates) the image/sound data transmitting session. Here, processing of leaving a conference room for transmission is the same.

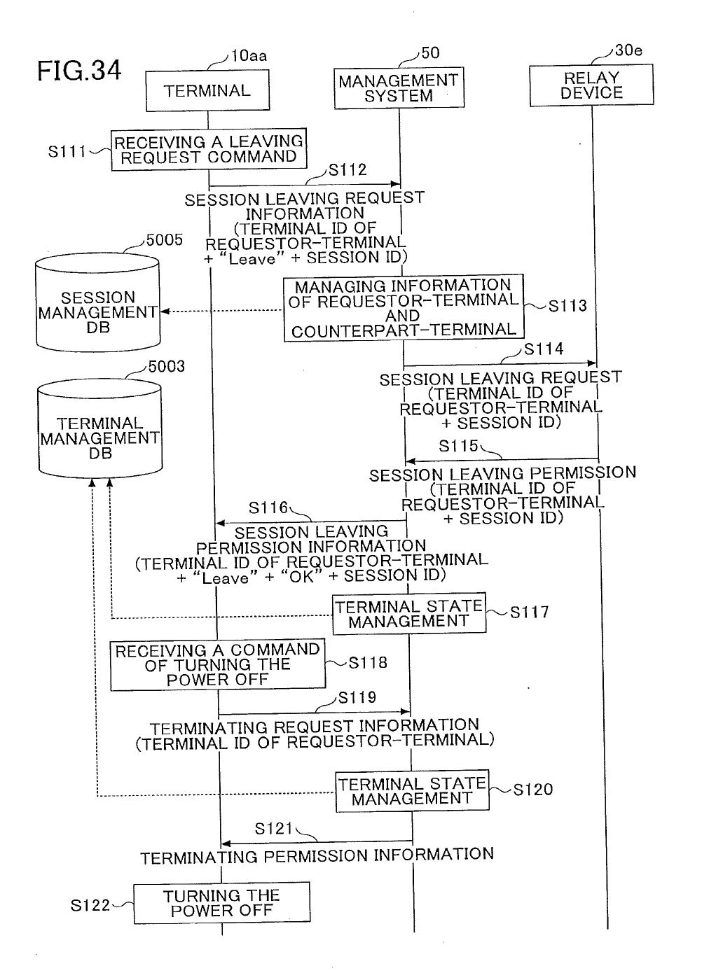

FIG. 34 is a sequence diagram illustrating the processing of leaving the image/sound data transmitting session. Here, communication in the sequence diagram of FIG. 34 is performed through the management information transmitting session sei.

First, a user of the requestor-terminal (i.e. terminal 10aa) presses the operation button 108 illustrated in FIG. 3, so that a request for leaving the image/sound data transmitting session sed is received (step S111). Then, the transmitter/receiver 11 provided in the requestor-terminal (i.e. terminal 10aa) sends to the management system 50 session leaving request information, which includes the terminal ID “01aa” of the requestor-terminal (i.e. terminal 10aa), change requesting information “Leave” indicative of requesting for leaving the image/sound data transmitting session, and the session ID “se2” (step S112)

Then, the session manager 57 deletes the terminal ID “01aa” of the requestor-terminal (i.e. terminal 10aa) from the “REQUESTOR-TERMINAL” field of the record having the session ID “se2”, in the session management table (illustrated in FIG. 10) of the non-volatile memory 5000 (step S113). The management system 50 sends to the relay device 30e a report indicating of requesting for leaving the session, which includes the terminal ID “01aa” and the requestor-terminal (i.e. terminal 10aa) and the session ID “se2” (step S114). In such a way, the relay device 30e stops the image/sound data transmitting session between the relay device 30e and the requestor-terminal (i.e. terminal 10aa), and terminates the connecting with the requestor-terminal (i.e. terminal 10aa). Then, the relay device 30e sends to the management system 50 a report indicative of permitting the leaving request, which includes the terminal ID “01aa” of the requestor-terminal (i.e. terminal 10aa) and the session ID “se2” (step S115).

After the management system 50 receives the report indicative of permitting the leaving request, the transmitter/receiver 51 sends to the requestor-terminal (i.e. terminal 10aa) session leaving permission information, which includes the terminal ID “01aa” of the requestor-terminal (i.e. terminal 10aa), the changing request information “Leave”, the session ID “se2”, and the report information “OK” indicative of permitting the leaving request (step S116). The state manager 53 of the management system 50 searches the terminal management table (illustrated in FIG. 8) based on the terminal ID “01aa” of the requestor-terminal (i.e. terminal 10aa) included in the session leaving request information, and updates the operating state of the record having the terminal ID “01aa” from the “ON-LINE (DURING CALL)” to “ON-LINE (READY FOR CALL)” (step S117).

Then, the requestor-terminal (i.e. terminal 10aa) receives a request for turning off the power when the power switch 109 illustrated in FIG. 3 is pressed (step S118). Upon receiving the request for turning off the power, the transmitter/receiver 11 sends to the management system 50 terminating request information, which includes terminal ID “01aa” of the requestor-terminal (i.e. terminal 10aa) and report information indicative of terminating the connection with the management system 50 (step S119).

When the transmitter/receiver 51 provided in the management system 50 receives the terminating request information, the state manager 53 searches the terminal management table (illustrated in FIG. 8) based on the terminal ID “01aa” of the requestor-terminal (i.e. terminal 10aa) included in the terminating request information, and then updates the operating state of the record having the terminal ID “01aa” from the “ON-LINE (READY FOR CALL)” to “OFF-LINE” (step S120). Then, the transmitter/receiver 51 sends to the requestor-terminal (i.e. terminal 10aa) terminating permission information indicative of permitting the leaving request (step S121). In such a way, the management system 50 stops the image/sound data transmitting session between the management system 50 and the requestor-terminal (i.e. terminal 10aa), and terminates the connection with the requestor-terminal (i.e. terminal 10aa).

Upon receiving the terminating permission information, the requestor-terminal (i.e. terminal 10aa) turns off the power, and terminates the processing (step S122).

<Advantage>

As described above, a terminal may perform a private communication with another terminal while continuing distributing of content data directed to multiple terminals. Further, the management system 50 may perform management of permitting and rejecting multiple connections at the same time.

There may be a problem in terms of privacy concerns that a parent may hear sound of a terminal for distributing video, etc., in a case, for example, of contacting another parent to inform of a rapid onset of fever of a child using the terminal. According to the first embodiment, as sound for distribution is halted (muted) when connecting to a call-session, privacy is protected.

### Second Embodiment

In the example of the first embodiment, the terminal 10 halts transmission of sound data in a second session, in an event of establishing a first session while the second session has been established, so as to change a quality of the transmission of the content data in the second session.

In the second embodiment, instead of/in addition to the first embodiment, the terminal 10 changes qualities of communication bands for transmitting content data in the second session, based on communication bands provided for communicating with the relay device 30, in a case of establishing a first session while a second session has been established.

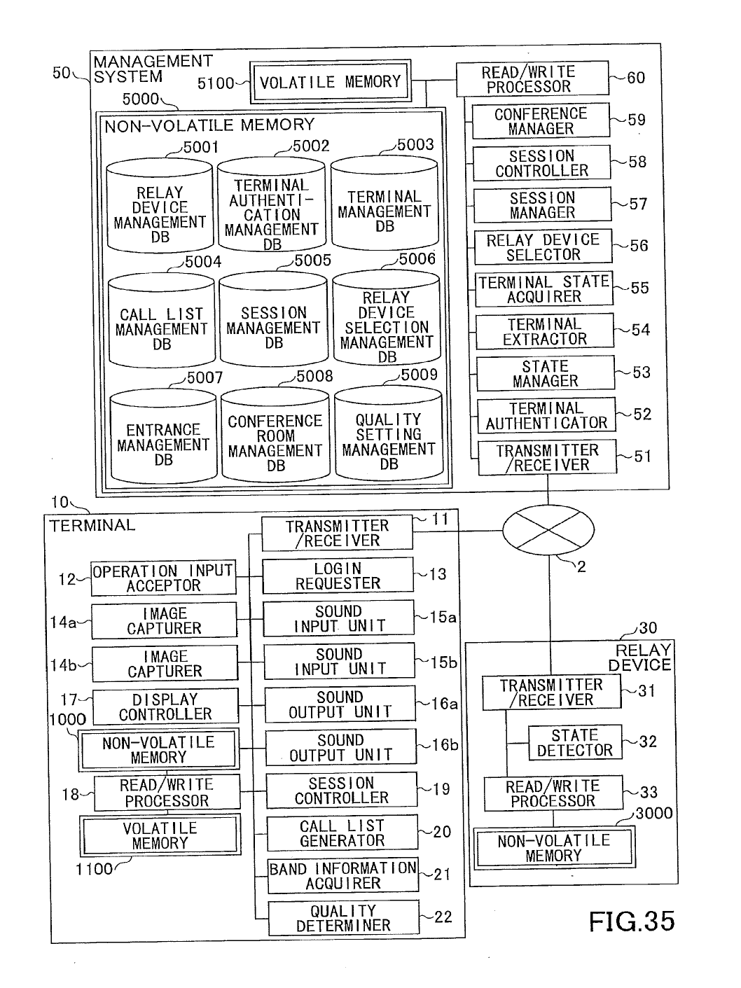

FIG. 35 is a functional block diagram illustrating an example of the respective terminals, devices, and systems that constitute a transmission system according to the second embodiment. Parts described below are different, compared to the functional block diagram according to the first embodiment illustrated in FIG. 5.

<Functional Configuration of the Management System>

The management system 50 further includes a quality setting management DB 5009.

(Quality Setting Management Table)

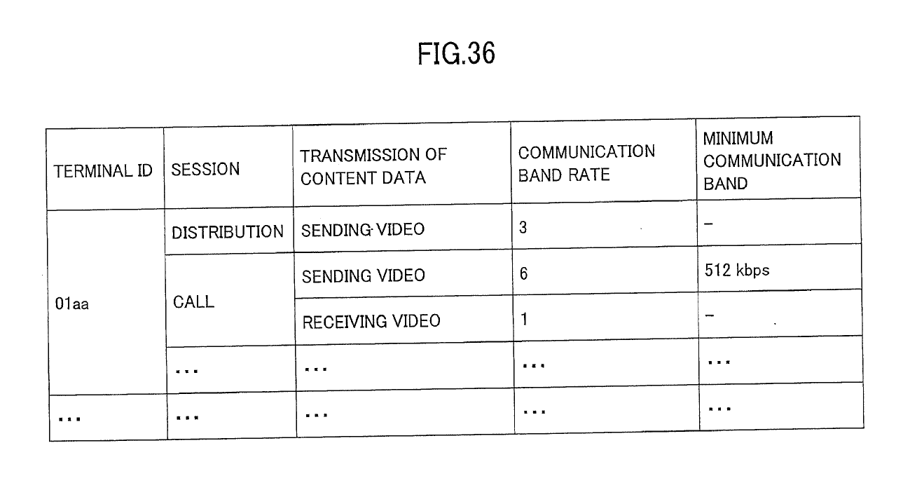

The non-volatile memory 5000 includes the quality setting management DB 5009 constituted by a quality setting management table illustrated in FIG. 36. The quality setting management table manages a ratio of a communication band assigned for transmitting each of content data in respective sessions and a setting of the minimum communication band assigned for transmitting each of the content data in the respective sessions, in association with respective terminal IDs of the terminals 10. For example, the quality setting management table illustrated in FIG. 36 indicates that, regarding the terminal 10 having the terminal ID “01aa”, the ratio of communication band assigned to transmission of content data “SENDING VIDEO” in a “DISTRIBUTION” session and transmission of content data “SENDING VIDEO” and “RECEIVING VIDEO” in a “CALL” session is 3: 6: 1 in order. The quality setting management table illustrated in FIG. 36 further indicates that setting of the minimum communication band assigned to the transmission of content data “SENDING VIDEO” in the “CALL” session is “512 kbps”.

The following description explains the functional block diagram of the management system 50.

The transmitter/receiver 51 of the management system 50 acquires from the quality setting management table, in response to a request from a terminal 10, quality setting information which includes the ratio of the communication band assigned for transmitting each of the content data in the respective sessions and the setting of the minimum communication band assigned for transmitting each of the content data in the respective sessions, based on the terminal ID of the terminal.

<Functional Configuration of Terminal>

The following description explains the terminal 10. The terminal 10 further includes a band information acquirer 21 and a quality determiner 22.

The band information acquirer 21 performs a communication band information acquiring process for acquiring information of communication bands between the terminal 10 and the relay device, in a case of establishing the first session with the first terminal while the second session is established with the second terminal. The band information acquirer 21 performs the communication band information acquiring process, for example regularly, while the established first session and second session are continuing. The communication band acquiring process will be described in detail later.

The quality determiner 22 acquires from the management system 50 through the transmitter/receiver 11 quality setting information managed in the quality setting management table in association with the terminal ID of the terminal 10. Here, the terminal 10 may be configured to preliminary store the quality setting information.

After the band information acquirer 21 acquires information of a communication band between the terminal 10 and a relay device, the quality determiner 22 performs quality determining processing for determining qualities of each of the transmissions of content data in the respective sessions, based on the information of the communication band and the quality setting information. Here, the details of the quality determining processing will be described later.

In a case of establishing the first session with the first terminal while the established second session with the second terminal is continuing, the session controller 19 changes a quality of communication for transmitting content data in respective sessions, based on the quality of the communication determined by the quality determiner 22. Here, qualities of communication for transmitting content data in respective sessions, which relate to communication band provided for content data, include resolutions, frame rate, etc., of a video.

In a case where the first session for communicating with the first terminal or the second session for communication with the second terminal is terminated, the session controller 19 changes the qualities of the communication of the content data in the respective session back to the original qualities.

The session controller 19 causes, through the transmitter/receiver 11, to perform transmission of content data in accordance with the qualities of transmitting content data in the respective sessions, which are determined by the quality determiner 22.

<<Processing/Operation of the Second Embodiment>>

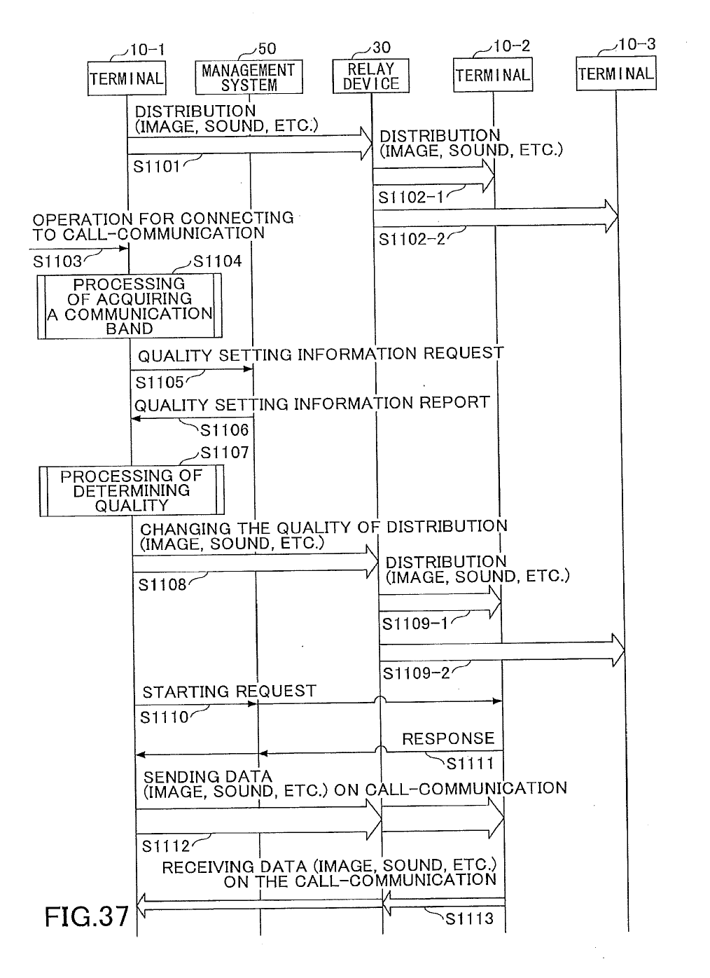

In the following, a processing method in the transmission system 1 according to the second embodiment will be explained, with reference to FIG. 37.

First, operation of the transmission system 1 at the time of performing a control process of a communication band according to the second embodiment will be explained, with reference to FIG. 37. FIG. 37 is a sequence diagram illustrating an example of the processing of performing the control process of the communication band.

A terminal 10-1 performs distribution of content data such as an image and sound using a distribution-session (step S1101).

The relay device 30 forwards the content data to receiver-terminals 10-2 and 10-3 (steps S1102-1 and S1102-2).

The terminal 10-1 receives a request for starting a call-session by a user through a command of selecting a counterpart-terminal (step S1103).

The terminal 10-1 performs band information acquiring processing for acquiring information of available communication bands between the terminal 10-1 and the relay device 30 (step S1104).

The terminal 10-1 requests the management system 50 to report quality setting information regarding content data of the distribution-session and the call-session (step S1105).

The management system 50 reports to the terminal 10-1 the quality setting information regarding content data of the distribution-session and the call-session (step S1106).

The terminal 10-1 performs quality determining processing for determining the qualities of transmission of the content data, based on the setting information reported by the management system 50 (step S1107).

The terminal 10-1 changes the qualities of the transmission of the content data in the distribution-session (step S1108).

The relay device 30 forwards the content data including an image data in a changed quality to the receiver-terminals 10-2 and 10-3 (steps S1109-1 and S1109-2)

The terminal 10-1 sends a request for starting a call-session to the counterpart-terminal 10-2 through the management system 50 (step S1110).

The terminal 10-1 receives a response from the counterpart-terminal 10-2 through the management system 50 (step S1111).

The terminal 10-1 sends data on a call-communication in the changed qualities through the relay device 30 (step S1112).

The terminal 10-1 changes qualities of receiving data in the call-session to the determined qualities (step S1113).

Here, the processing of changing the qualities of the transmission of content data in the call-session, which is performed in step S1108, may be performed after receiving the response from the counterpart-terminal 10-2 in step S1111.

Here, the processing of changing the qualities of the receiving data to the determined qualities, which is performed in step S1113, may be performed as described below. The terminal 10-1 sends a predetermined command to either one of the counterpart-terminal 10-2 or the relay device 30. Upon receiving the command, the either one of the counterpart-terminal 10-2 or the relay device 30 controls the qualities of the data receiving from the counterpart-terminal 10-2 to qualities in accordance with the command. Alternatively, in a case where the relay device 30 has a function of controlling the qualities of data receiving from the counterpart-terminal 10-2 in accordance with a delay-time reported by the terminal 10-1, the relay device 30 may be configured to control the qualities of data receiving from the counterpart-terminal 10-2 when the terminal 10-1 reports a predetermined delay-time to the relay device 30.

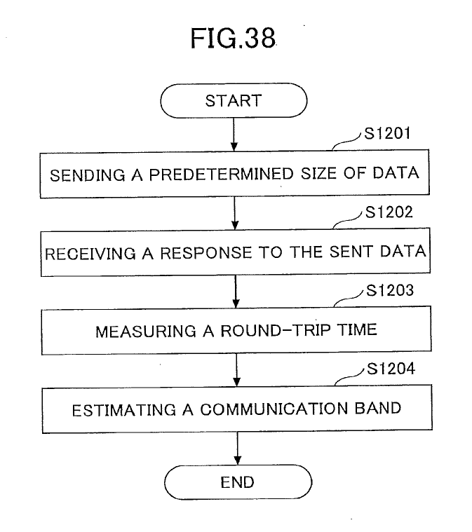

In the following, a detailed example of a band information acquiring process illustrated in step S1103 of FIG. 37, which is performed by the band information acquirer 21 provided in the terminal 10-1, will be explained with reference to FIG. 38. FIG. 38 is a flowchart illustrating an example of the band information acquiring process.

The band information acquirer 21 sends a predetermined size of data (i.e. transmit-data) to the relay device 30 using, for example, a common ping (step S1201).

The band information acquirer 21 receives a response to the transmit-data from the transmitter/receiver 31 provided in the relay device 30 (step S1202).

The band information acquirer 21 measures time elapsing from sending the transmit-data until receiving the response (i.e. round-trip time) (step S1203).

The band information acquirer 21 measures a communication band between the terminal 10-1 and the relay device 30 based on the size of the transmit-data, the size of the received-data (i.e. response), and the lapsed time, using, for example, an equation below (step S1204).

COMMUNICATION BAND=(SIZE OF TRANSMIT-DATA+SIZE OF RECEIVED-DATA)×COEFFICIENTα/LAPSED TIME

Here, the sizes of data are the same when using a ping. Here, the COEFFICIENTα is a coefficient which is predetermined in consideration of fluctuation of a communication network, an accidental error of an estimate value, etc. Information of the COEFFICIENTα may be acquired from the management system 50 or may be preliminarily stored in the terminal 10-1.

Here, the communication band may be obtained by use of a chart indicative of an estimate value of a communication band per a lapsed time, instead of calculating by use of the equation above. Here, the method for estimating the communication band may be something else. For example, the terminal 10-1 may send a predetermined size of transmit-data to the relay device 30 using Transmission Control Protocol (TCP) or Real-time Transport Protocol (RTP), and then receive an acknowledgement from the relay device 30. Then, the communication band may be estimated through dividing the size of the transmit-data by lapsed time from sending the transmit-data until receiving the acknowledgement and then multiplying by a predetermined coefficient.

The band information acquirer 21 may be configured to acquire information of a communication preliminary stored in the terminal 10, or may be configured to acquire information of a communication band from the management system 50, instead of obtaining information of a communication band through measurements.

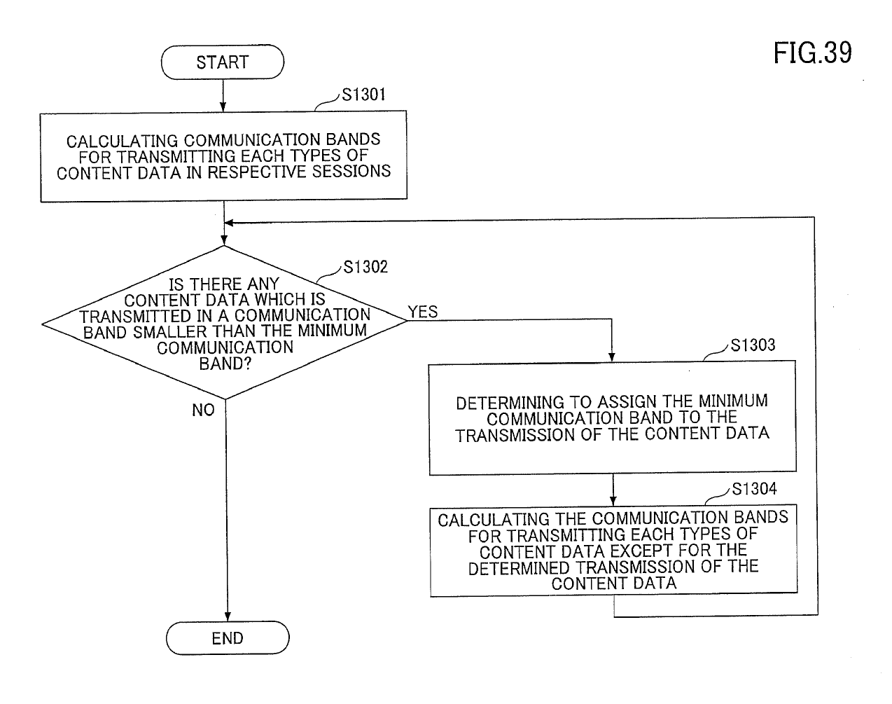

In the following, a detailed example of a quality determining process illustrated in step S1106 of FIG. 36, which is performed by the quality determiner 22 provided in the terminal 10-1. FIG. 39 is a flowchart illustrating an example of the quality determining process.

The quality determiner 22 calculates a communication band for transmitting content data in a communication of respective sessions based on a communication band measured by the band information acquirer 21 and a proportion of content data in a communication of the respective session (step S1301).

The quality determiner 22 determines whether, among communications of transmitting content data in the respective sessions, there are any communications transmitting content data through a communication band which is smaller than the minimum communication band, which is obtained from the management system 50, assigned to each of the communications transmitting content data in the respective sessions (step S1302).

In a case where there are not any communications transmitting content data through a communication band which is smaller than the minimum communication band (NO in step S1302), the quality determiner 22 terminates the processing.

In a case where there are communications transmitting content data through a communication band which is smaller than the minimum communication band (YES in step S1302), the quality determiner 22 determines to assign the minimum communication band corresponding to each of the communications of transmitting content data as the communication band for transmitting the content data.

The quality determiner 22 calculates communication bands for transmitting content data in respective sessions based on communication band ratio of transmission of content data in the respective sessions, which is obtained from the management system 50, except for the determined one or more communication of transmitting content data (step S1304).

The sequence returns to step S1302 regarding to the communications of transmitting content data in the respective sessions.

In the example of the quality setting management table illustrated in FIG. 36, in a case where the communication band between the terminal and the relay device 30 acquired by the band information acquirer 21 is 1 Mbps (i.e. 1024 kbps), a communication band assigned to the “SENDING VIDEO” in the session of “DISTRIBUTION” is obtained by an equation: 1024×3/(3+6+1)−307 kbps. Similarly, a communication band assigned for the “SENDING VIDEO” in the session of “CALL” is obtained by an equation: 1024×6/(3+6+1)=614 kbps.

In a case where the communication band between the terminal and the relay device 30 acquired by the band information acquirer 21 is 0.6 Mbps (i.e. 614 kbps), a communication band assigned for the “SENDING VIDEO” in the session of “CALL” is determined to be “512 kbps” which is predetermined as the minimum communication band. In such a case, a communication band assigned to the “SENDING VIDEO” in the session of “DISTRIBUTION” is obtained by an equation: (614−512)×3/(3+1)=77 kbps.

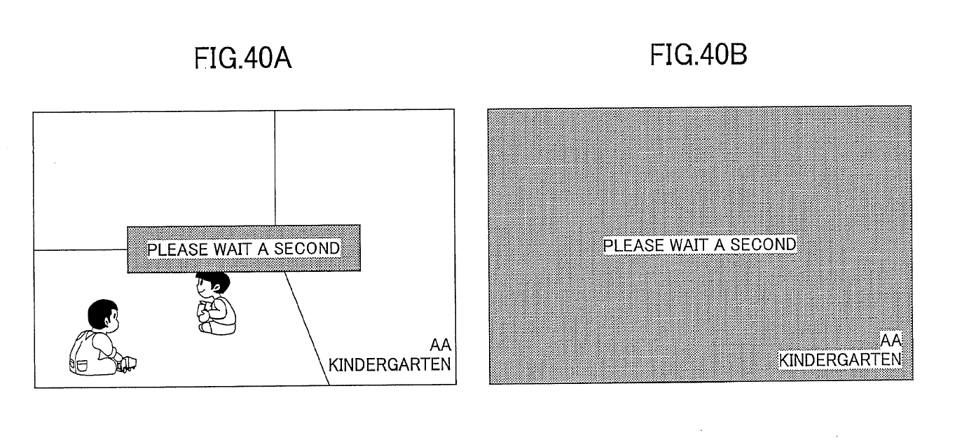

In the following, an example of a display screen on the counterpart-terminal in a case where a communication band for video distribution is smaller than a predetermined threshold value will be described with reference to FIG. 40.

In a case where the communication band assigned for the “SENDING IMAGE” of the session of “DISTRIBUTION” is smaller than a first threshold value, the session controller 19 sends a predetermined command to the counterpart-terminal 10, so that the last image sent in the distribution-session is displayed on the counterpart-terminal 10 in a form of a still image as illustrated in FIG. 40A, for example.

In a case where the communication band assigned for the “SENDING IMAGE” of the session of “DISTRIBUTION” is smaller than a second threshold value, the session controller 19 sends a predetermined command to the counterpart-terminal 10, so that a message with a gray color background is displayed on the counterpart-terminal 10 as illustrated in FIG. 40B, for example.

In a case where the communication band for communication with the relay device 30, which is obtained by the band information acquirer 21, is smaller than the minimum communication band for the communication of “SENDING VIDEO” in the “CALL” session, the session controller 19 assigns the entire value of the obtained communication band to the communication of “SENDING VIDEO” in the session of “CALL” session and sends a predetermined command to the counterpart-terminal 10, so that a message with a gray color background is displayed on the counterpart-terminal 10, for example.

<Advantage>

In a case of establishing multiple sessions at the same time, there may be a problem, for example, that the quality of video is decreased, depending on a condition of a network, due to a lack of communication band assigned for the call-session as a distribution-session consumes communication band.

For example, in a case of calling a parent to inform of a rapid onset of fever of a child, etc., using a terminal placed at a kindergarten which distributes video, etc., a video transmitted in a call-session is desired to be clear enough to convey a detailed facial expression of the child. On the other hand, it is considered that the quality of a distributed video needs not to be as clear all the time, as long as one can see the circumstance of a distributing location.

According to the second embodiment, as the highest-priority session is automatically determined and communication bands assigned for other sessions are restricted, the quality of an image in the highest-priority session is secured. Therefore, for a temporary period of time until the call-communication is terminated, consumption of communication band assigned for transmitting an image in a distribution-session is restricted, so as to secure the quality of a high-priority image, such as an image transmitted in a call-session.

<<Supplemental Description of Embodiments>>

The call list generator 20 which generates a counterpart-terminal state list image used as a call list, may be provided in the management system 50, not in the terminal 10. In such a case, it may be determined that the terminal 10 is involved in a distribution-session or a call-session in a case where the operating state of the terminal 10 is either one of “ON-LINE (DURING DISTRIBUTION)” of “ON-LINE (DURING CALL)”. In such a way, the process of displaying a call list on the terminal 10 may be skipped.

Further, the management system 50 and the program-providing system 90 according to the above embodiments may be constituted by a single computer, or the parts (i.e. functions/methods) of the management system 50 and the program-providing system 90 may be divided and provided in multiple computers so that the management system 50 and the program-providing system 90 are constituted by multiple computers. Further, in a case where the program-providing system 90 is constituted by a single computer, programs may be sent through multiple modules or through a single module. Further, in a case where the program-providing system 90 is constituted by multiple computers, programs may be sent through multiple modules from the respective computers.

Further, the recording medium storing the terminal-oriented programs, the relay device-oriented programs, and the transmission management programs, and the HO 204 storing such programs, and the program-providing system 90 storing the HD 204 are utilized by domestic and foreign users, etc., when provided as a program product.

In the embodiments, “teleconference” is a term which is replaceable with “video conference”.

Further, although in the above embodiments, a teleconference system is described as an example of the transmission system 1, the transmission system 1 is not limited to a teleconference system and may be a phone system such as an Internet Protocol (IP) phone and an internet phone. Further, the transmission system 1 may be a car navigation system. In this case, for example, a car navigation device provided on a car corresponds to a terminal 10 while a management terminal or a management server provided at a management center that manages car navigations corresponds to another terminal 10. Further, the transmission system 1 may be an sound conference system or PC screen sharing system.

Further, although the description of above embodiments explains a case of having a teleconference using the transmission system 1, the transmission system 1 is not limited to such a case and may be utilized for having a meeting or a general conversation of family members and friends, or may be utilized for one-way transmission of information.

Further, although the description of the above embodiments explains a case where the terminal 10 is a dedicated terminal as illustrated in FIG. 2, the terminal 10 may be a general-purpose terminal such as a smartphone and a PC. In other words, the terminal-oriented programs may be installed and executed by a general-purpose terminal such as a smartphone and a PC.

Further, the present invention is not limited to these embodiments, but various variations and modifications may be made without departing from the scope of the present invention.

What is claimed is:

1. A management system comprising:
a receiver configured to receive a request sent from a first terminal for establishing a first session between the first terminal and a second terminal; and
a session controller configured to send the request for establishing the first session to the second terminal while a second session, other than the first session, is underway between the first terminal and a third terminal, upon receiving the request for establishing the first session.

2. The management system according to claim 1,
wherein the session controller determines whether to send the request for establishing the first session to the second terminal, based on information indicating whether the first terminal is capable of establishing the first session and the second session at the same time.

3. The management system according to claim 1,
wherein, upon receiving the request for establishing the first session while the second terminal is in the second session, the session controller sends the request for establishing the first session to the second terminal after excluding the second terminal from the second session.

4. The management system according to claim 1,
wherein the session controller halts distribution of sound data transmitted from the first terminal in the second session in an event of establishing the first session while the second session is underway.

5. The management system according to claim 4,
wherein the session controller informs the third terminal, at the time of halting the distribution of the sound data, that the distribution of sound data is halted.

6. A transmission terminal comprising:
a session controller configured to change a quality of transmission of content data in a second session, in an event of establishing a first session with a first terminal while the second session is underway with a second terminal; and
a communicator configured to perform the transmission of content data in the second session in accordance with the changed quality.

7. The transmission terminal according to claim 6,
wherein the first session is for communicating with the first terminal,
wherein the second session is for distributing content data including sound data to the second terminal, and
wherein the session controller halts the distribution of sound data through the communicator, so as to change the quality of transmission of content data in the second session.

8. The transmission terminal according to claim 7,
wherein the session controller records content data in an event that the first session is not able to be established, and
wherein the communicator sends the recorded content data to the first terminal.

9. The transmission terminal according to claim 6, the transmission terminal further comprising:
a communication band acquirer configured to acquire information concerning a communication band provided for communication with a relay device that relays content data in the first session and the second session; and
a quality determiner configured to determine the quality of transmission in the first session and the second session, based on the acquired information concerning the communication band,
wherein the session controller changes the quality of transmission of content data in the second session, based on the determined quality of transmission.

10. The transmission terminal according to claim 9,
wherein the quality determiner determines the quality of transmission of content data based on a rate assigned to the transmission of content data or a minimum communication band corresponding to the transmission of content data.

11. A method for transmission management implemented by a management system, the method including:
receiving a request sent from a first terminal for establishing a first session between the first terminal and a second terminal; and
sending the request for establishing the first session to the second terminal, in an event that the receiver receives the request for establishing the first session while a second session, other than the first session, is underway between the first terminal and a third terminal.
